(19) United States
(12) Patent Application Publication
(10) Pub. No.: US 2025/0059022 A1
(43) Pub. Date: Feb. 20, 2025

(54) CLIP ENGAGING MEMBER FOR COVER MATERIAL FIXTURE AND COVER MATERIAL FIXTURE

(71) Applicant: YKK CORPORATION, Chiyoda-ku, Tokyo (JP)

(72) Inventors: Yuta Inoue, Chiyoda-ku, Tokyo (JP); Madoka Nanbu, Kurobe-shi, Toyama (JP); Zhiyu Ren, Kurobe-shi, Toyama (JP); Wanli Zhang, Kurobe-shi, Toyama (JP)

(21) Appl. No.: 18/721,504

(22) PCT Filed: Dec. 12, 2022
(86) PCT No.: PCT/JP2022/045587

§ 371 Date: Jun. 18, 2024

(30) Foreign Application Priority Data
Dec. 21, 2021 (JP) 2021-207180

(51) Int. Cl. B68G 7/12; A47C 31/02; B60N 2/60

(52) U.S. Cl. CPC B68G 7/12; A47C 31/023; B60N 2/6027

(57) ABSTRACT

A clip engagement member forms a cover material attachment with a clip that is attachable to one of a cushion material and a cover material and includes a pair of claws. The clip engagement member includes: a base attachable to the other of the cushion material and the cover material; and a body extending from the base and insertable in the clip along an extending direction. The body includes: a pair of lateral parts facing opposite sides to each other in a thickness direction intersecting with the extending direction, at least one of which is configured to face the claw; an engagement portion formed in the at least one of the lateral parts and engageable with the claw; and a disengagement guide formed in the at least one of the lateral parts and configured to guide the claw in the extending direction.

### TECHNICAL FIELD

The present invention relates to a clip engagement member of a cover material attachment and a cover material attachment.

### BACKGROUND ART

Parts of a vehicle seat or a chair for indoor use which are to come into contact with a human body, such as a seating surface and a backrest, typically include a cushion material such as a molded foam and a cover material such as leather covering a surface of the cushion material. Further, as a means of fixing an end of the cover material to the cushion material, there is known a cover material attachment including a clip located in a groove of the cushion material and a clip engagement member coupled to the end of the cover material (see, for instance, Patent Literature 1).

### CITATION LIST

### Patent Literature(s)

Patent Literature 1: US Patent Application Publication No. 2002/0101109

### SUMMARY OF THE INVENTION

### Problem(s) to be Solved by the Invention

In the known cover material attachment as described in Patent Literature 1, however, a cover material is not meant to be removed from the cushion material. Thus, when the cover material is removed from the cushion material, there are required a complicated disengagement operation using a jig or a work of destroying a component of the cover material attachment using a jig. This increases the time and effort of a worker. Further, in a case where the component of the cover material attachment is destroyed, a cost for preparation of a new component is needed to attach the cover material to the cushion material again.

An object of the invention is to provide a clip engagement member of a cover material attachment that facilitates removal of a cover material from a cushion material and a cover material attachment.

### Means for Solving the Problem(s)

According to a first aspect of the invention, there is provided a clip engagement member forming a cover material attachment together with a clip that is to be attached to one of a cushion material and a cover material, the clip including a single claw or a pair of claws facing each other, the clip engagement member including: a base that is to be attached to another one of the cushion material and the cover material; and a body extending from the base and that is to be inserted in the clip along an extending direction, the body including: a pair of lateral parts facing opposite sides to each other in a thickness direction intersecting with the extending direction, at least one of the lateral parts being configured to face the claw; an engagement portion formed in the at least one of the lateral parts, the engagement portion being engageable with the claw; and a disengagement guide formed in the at least one of the lateral parts across a range from a position adjacent to the engagement portion in a length direction intersecting with each of the extending direction and the thickness direction to a distal end in the extending direction, the disengagement guide being configured to guide the claw in the extending direction.

In the first aspect of the invention, it is possible to attach the cover material to the cushion material by inserting the body of the clip engagement member into the clip and engaging the engagement portion formed in at least one of the pair of lateral parts of the body with the claw of the clip.

In a state where the clip engagement member is engaged with the clip, it is possible to move the claw to the disengagement guide by moving the clip engagement member in the length direction relative to the clip. Then, moving the clip engagement member relative to the clip in the opposite direction to the extending direction causes the claw to be guided along the disengagement guide, making it possible to pull the body out of the clip. It is thus possible to disengage the clip engagement member from the clip without a component breakage or a complicated disengagement operation, facilitating the removal of the cover material from the cushion material.

In the first aspect of the invention, the disengagement guide may have a flat shape extending across the range of the at least one of the lateral parts or may include a stepped portion including a plurality of steps formed in the extending direction.

In the first aspect of the invention, it is preferable that a dimension of the body in the thickness direction defined by the disengagement guide gradually decreases toward the extending direction.

Such a configuration favorably guides the claw.

In the first aspect of the invention, the at least one of the pair of lateral parts is preferably provided with a recess opening in the lateral part, and the engagement portion preferably has an engagement surface formed in the recess to face an opposite direction to the extending direction.

In such a configuration, the claw is received in the recess, which makes it possible to inhibit unintentional disengagement of the clip engagement member.

In the first aspect of the invention, the recess preferably has an inclined surface facing an opening of the recess, the inclined surface extending from a bottom of the recess to an edge of the recess while being inclined to the length direction, the edge being adjacent to the disengagement guide.

In such a configuration, the claw slides on the inclined surface of the recess in disengaging the clip engagement member from the clip, so that the claw can easily come out of the recess.

In the first aspect of the invention, the edge of the recess preferably protrudes toward the thickness direction beyond the disengagement guide adjacent to the edge.

In such a configuration, when the clip engagement member is moved relative to the clip in the length direction, a click feeling is provided by moving the claw from the edge of the recess to the disengagement guide.

In the first aspect of the invention, it is preferable that the body further includes an engagement guide formed, in the at least one of the pair of lateral parts, on a side closer to the distal end in the extending direction than the engagement portion, the engagement guide being inclined to the extending direction, and that a dimension of the body in the thickness direction defined by the disengagement guide gradually decreases toward the extending direction.

Such a configuration facilitates an operation of inserting the body of the clip engagement member into the clip.

In the first aspect of the invention, the engagement guide may have an inclined surface inclined to the extending direction or a stepped portion including a plurality of steps formed in the extending direction.

In the first aspect of the invention, the body preferably further includes a projection in the at least one of the pair of lateral parts, the projection projecting in the thickness direction.

In such a configuration, a worker presses the projection, facilitating an operation on the clip engagement member.

In the first aspect of the invention, it is preferable that one or more engagement portions including the engagement portion and a plurality of disengagement guides including the disengagement guide are alternately formed in the length direction in the at least one of the pair of lateral parts.

In such a configuration, in disengaging the clip engagement member from the clip, it is possible to move the clip engagement member toward either side in the length direction relative to the clip. Further, in a case where there are a plurality of engagement portions, it is possible to adjust an engaged position of the clip engagement member relative to the clip and engage the clip engagement member with a plurality of clips.

In the first aspect of the invention, the body preferably further includes at least one restricting protrusion protruding in the thickness direction from one side in the length direction of the engagement portion.

In such a configuration, in disengaging the clip engagement member from a plurality of clips, the restricting protrusion comes into contact with the claw of one of the clips, making it possible to inhibit an excessive movement of the clip engagement member relative to the clip.

In the first aspect of the invention, the engagement portion preferably includes a plurality of protrusions protruding in the thickness direction from the at least one of the lateral parts, the plurality of protrusions being arranged in the length direction.

Such a configuration facilitates the attachment of the cover material even in a case where a portion of the cushion material for the cover material to be attached is curved.

According to a second aspect of the invention, there is provided a cover material attachment including: the clip engagement member according to any of the above; and the clip, in which the clip includes: a clip base that is to be attached to one of the cushion material and the cover material; a pair of legs provided for the clip base, the pair of legs facing each other; and the claw provided for at least one of the pair of legs.

The cover material attachment according to the second aspect of the invention produces effects similar to the effects described in relation to the clip engagement member according to the above first aspect.

It is preferable that the cover material attachment according to the second aspect of the invention further includes: a clip assembly provided with a plurality of integrally formed clips including the clip, the plurality of clips being arranged in the length direction; and a clip restricting protrusion, in which the at least one of the pair of lateral parts includes: one or more engagement portions including the engagement portion and a plurality of disengagement guides including the disengagement guide alternately formed in the length direction with a restricting surface formed between the engagement portion and the disengagement guide, the restricting surface facing the length direction, and the clip restricting protrusion protrudes from the clip base between adjacent two of the clips, the clip restricting protrusion being configured to come into contact with the restricting surface.

In such a configuration, in disengaging the clip engagement member from the clip assembly, the clip restricting protrusion comes into contact with the restricting surface formed between one of the engagement portions and the corresponding disengagement guide, which makes it possible to inhibit an excessive movement of the clip engagement member relative to the clip assembly.

In the second aspect of the invention, it is preferable that, in a case where the recess is formed, the claw has a claw guiding inclined surface inclined to the length direction to face a bottom of the recess and face an edge of the recess, the edge being adjacent to the disengagement guide.

In such a configuration, the claw guiding inclined surface slides on the edge of the recess in disengaging the clip engagement member from the clip, so that the claw can easily come out of the recess.

According to a third aspect of the invention, there is provided a cover material attachment including a clip and a clip engagement member, the clip including: a clip base that is to be attached to one of a cushion material and a cover material; a pair of legs provided for the clip base; and a claw provided for at least one of the pair of legs, the clip engagement member including: an engagement member base that is to be attached to another one of the cushion material and the cover material; and a body extending from the engagement member base, the body being to be inserted into between the pair of legs along an extending direction, in which the body includes a plurality of engagement portions arranged in parallel at an interval along a length direction intersecting with the extending direction, the plurality of engagement portions being engageable with the claw, the claw is configured to perform, in sequence, a first movement including a relative movement in the length direction from a state of being engaged with one of the engagement portions and a second movement including a relative movement in an opposite direction to the extending direction from a state of being placed between two of the engagement portions adjacent in the length direction, and the second movement of the claw causes the body to come out from between the pair of legs.

The third aspect of the invention produces effects similar to those of the first and second aspects.

In the third aspect of the invention, the body preferably includes a slit between ones of the engagement portions adjacent in the extending direction, the slit being cut from a distal end in the extending direction.

In such a configuration, the slit functions similarly as the above disengagement guide.

### BRIEF DESCRIPTION OF DRAWINGS

FIG. 1 is a perspective view illustrating an installed state of a cover material attachment according to a first exemplary embodiment of the invention.

FIG. 2 illustrates an exemplary seat where the cover material attachment of the first exemplary embodiment is to be used.

FIG. 3 is a side view illustrating a clip of the cover material attachment of the first exemplary embodiment.

FIG. 4 is a front view illustrating a clip engagement member of the cover material attachment of the first exemplary embodiment.

FIG. 5 is a bottom view illustrating the clip engagement member of the cover material attachment of the first exemplary embodiment.

FIG. 6 is a perspective view illustrating an engaged state of the clip and the clip engagement member in the first exemplary embodiment.

FIG. 7 is a diagram to explain an engagement operation for the clip and the clip engagement member in the first exemplary embodiment.

FIG. 8 is a cross-sectional view taken along a line A-A in FIG. 4, illustrating the engaged state of the clip and the clip engagement member in the first exemplary embodiment.

FIG. 9 is a diagram to explain a relative movement of claws in the first exemplary embodiment.

FIG. 10 is a cross-sectional view taken along a line B-B in FIG. 4, FIG. 10 being a diagram to explain a disengagement operation for the clip and the clip engagement member in the first exemplary embodiment.

FIG. 11 is a diagram to explain an exemplary location of the claws relative to the clip engagement member.

FIG. 12 is a bottom view illustrating a clip engagement member according to a modification example of the first exemplary embodiment.

FIG. 13 is a front view illustrating a clip engagement member according to another modification example of the first exemplary embodiment.

FIG. 14 is a front view illustrating a clip engagement member according to still another modification example of the first exemplary embodiment.

FIG. 15 is a perspective view illustrating a cover material attachment according to a second exemplary embodiment of the invention.

FIG. 16 is a diagram to explain a relative movement of the claws in the second exemplary embodiment.

FIG. 17 is a perspective view illustrating a clip assembly according to a first modification example of the second exemplary embodiment.

FIG. 18 is a perspective view illustrating a clip engagement member according to a second modification example of the second exemplary embodiment.

FIG. 19 is a cross-sectional view illustrating the clip engagement member according to the second modification example of the second exemplary embodiment and the clip assembly.

FIG. 20 is a perspective view illustrating a cover material attachment according to a third exemplary embodiment of the invention.

FIG. 21 is a cross-sectional view illustrating the cover material attachment according to the third exemplary embodiment.

FIG. 22 is a perspective view illustrating a cover material attachment according to a fourth exemplary embodiment of the invention.

FIG. 23 is a plan view illustrating a clip according to the fourth exemplary embodiment.

FIG. 24 is a diagram to explain a relative movement of claws in the fourth exemplary embodiment.

FIG. 25 is a perspective view illustrating a clip engagement member according to a fifth exemplary embodiment of the invention.

FIG. 26 is a plan view illustrating the clip engagement member according to the fifth exemplary embodiment.

FIG. 27 is a cross-sectional view taken along a line C-C in FIG. 26.

FIG. 28 is a cross-sectional view illustrating a cover material attachment according to a modification example.

FIG. 29 is a perspective view illustrating a clip engagement member according to a modification example.

### DESCRIPTION OF EMBODIMENT(S)

Description will be made below on a plurality of exemplary embodiments of the invention. It should be noted that in a second exemplary embodiment and thereafter, the same reference signs are used for components configured similarly to those of a first exemplary embodiment and the description thereof is omitted or simplified.

### First Exemplary Embodiment

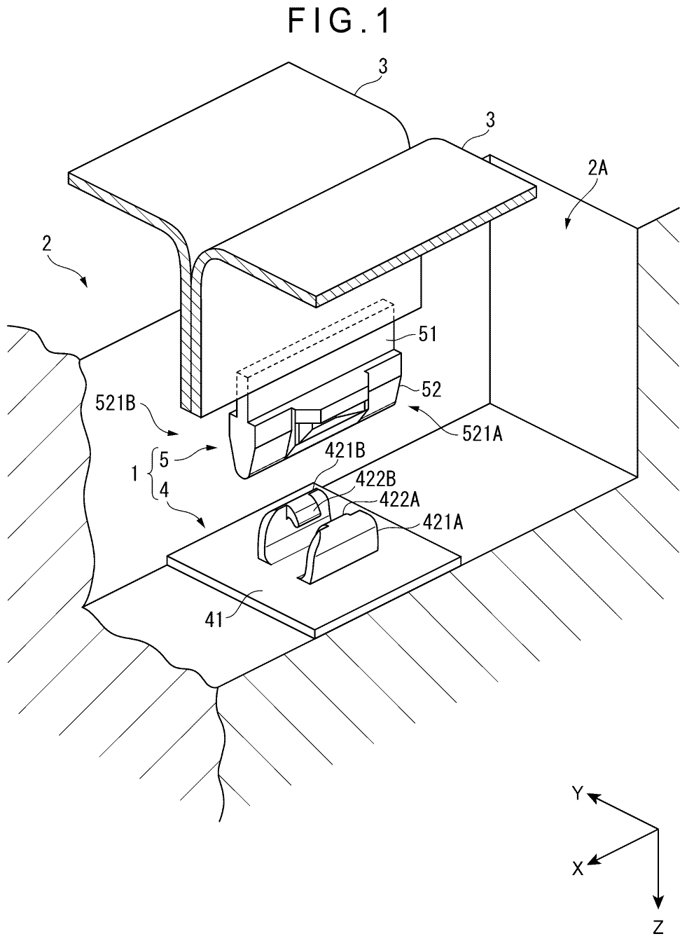

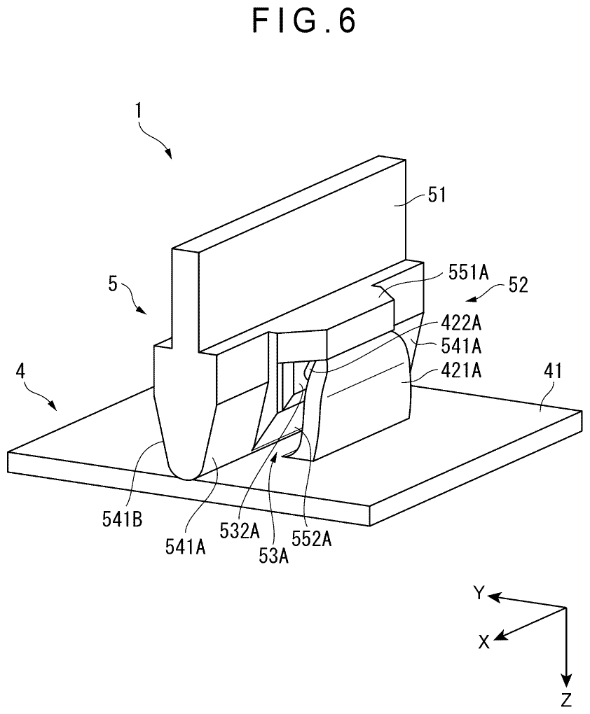

Referring to FIGS. 1 to 10, description will be made on the first exemplary embodiment of the invention.

In FIG. 1, a cover material attachment 1 according to the exemplary embodiment is configured to attach a cover material 3 to a cushion material 2 forming a seat or the like. The cover material attachment 1 includes a clip 4 to be attached to the cushion material 2 and a clip engagement member 5 to be attached to the cover material 3.

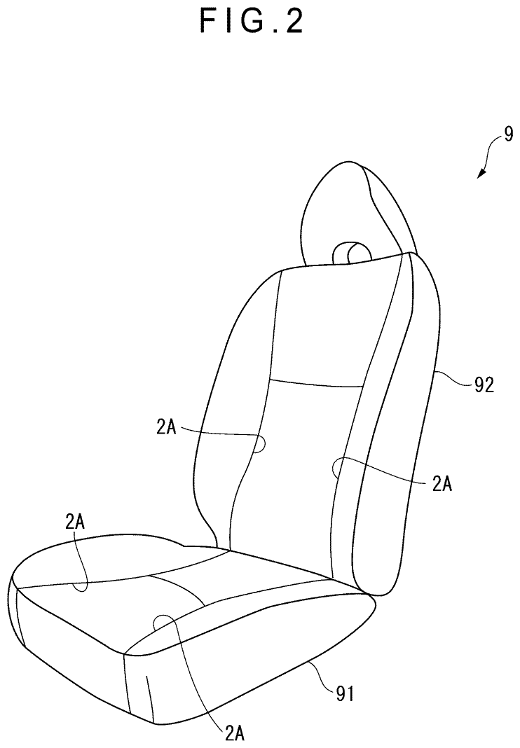

The cushion material 2 of the exemplary embodiment includes a synthetic resin urethane foam such as expanded polyurethane. The cushion material 2 is in a form of a portion of a seat 9 (e.g., a seat part 91 or a backrest part 92) as illustrated in FIG. 2 and is provided with a groove(s) 2A extending in a desired direction. The cover material 3 of the exemplary embodiment includes a synthetic resin woven sheet or the like that covers a surface of the cushion material 2.

It should be noted that although the illustration is omitted in FIG. 1, a plurality of cover material attachments 1 arranged along the groove(s) 2A may be used to attach the cover material 3 to the cushion material 2.

### Clip 4

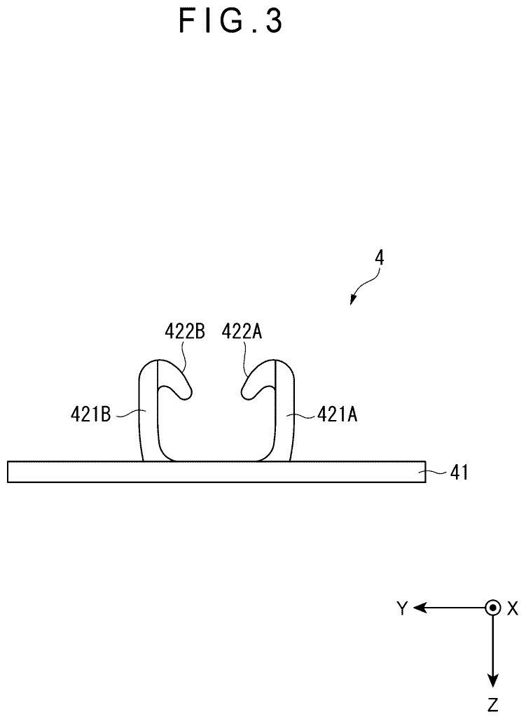

Referring to FIG. 1 and FIG. 3, description will be made on the clip 4.

The clip 4 is integrally formed from an elastic material such as synthetic resin. The clip 4 includes a base 41 (corresponding to a clip base of the invention), a pair of legs 421A and 421B provided for the base 41, and a pair of claws 422A and 422B provided for the pair of legs 421A and 421B.

The base 41 is formed, for instance, into a plate shape and is to be fixed to a bottom of the groove 2A of the cushion material 2 with an adhesive or the like (see FIG. 1).

The legs 421A and 421B face each other at an interval. The claws 422A and 422B protrude in directions to approach each other from the legs 421A and 421B. The claws 422A and 422B face each other.

### Clip Engagement Member

Referring to FIGS. 1, 4, and 5, description will be made on the clip engagement member 5.

The clip engagement member 5 includes a base 51 (corresponding to an engagement member base of the invention) to be attached to an end of the cover material 3 and a body 52 extending from the base 51.

In the exemplary embodiment, the base 51 may include a resin material integrally molded with the body 52 or a tape member, such as unwoven fabric, insert-molded with respect to the body 52. The base 51 is to be fixed to the cover material 3 by means of sewing or the like.

Here, a direction for the body 52 to extend from the base 51 (an extending direction of the invention) is defined as a Z direction (also referred to as a +Z direction). The body 52 has such a thickness to be insertable in between the legs 421A and 421B in a Y direction (corresponding to a thickness direction of the invention) orthogonal to the Z direction. Further, the body 52 has a length extending along an X direction (corresponding to a length direction of the invention) orthogonal to each of the Z direction and the Y direction. The X direction corresponds to a direction along the end of the cover material 3.

The body 52 includes a pair of lateral parts 521A and 521B facing opposite sides to each other in the Y direction. The lateral parts 521A and 521B are configured to face the respective claws 422A and 422B. The body 52 includes an engagement portion 53A and a disengagement guide 541A formed in the lateral part 521A, and an engagement portion 53B and a disengagement guide 541B formed in the lateral part 521B.

It should be noted that in the exemplary embodiment, respective disengagement guides 541A are formed on both sides in the X direction relative to the engagement portion 53A and respective disengagement guides 541B are formed on both sides in the X direction relative to the engagement portion 53B.

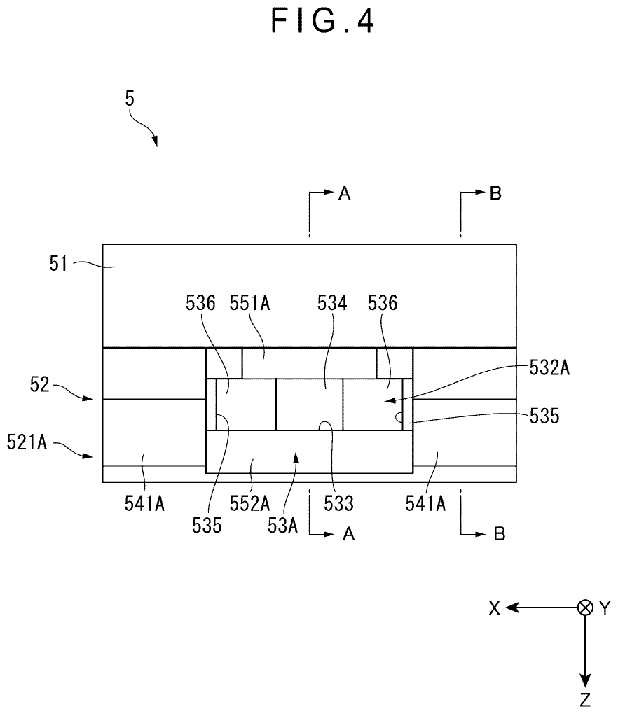

FIG. 4 illustrates the lateral part 521A out of the pair of lateral parts 521A and 521B. In this regard, since the pair of lateral parts 521A and 521B in the exemplary embodiment are plane symmetry with respect to an XZ-plane, the lateral part 521B has a similar shape to that of the lateral part 521A illustrated in FIG. 4.

In the exemplary embodiment, recesses 532A and 532B are formed to open in the respective lateral parts 521A and 521B. The engagement portions 53A and 53B of the exemplary embodiment are formed by the recesses 532A and 532B of the lateral parts 521A and 521B, respectively. The engagement portions 53A and 53B each include a later-described engagement surface 533.

As illustrated in FIG. 4, the recess 532A has a bottom 534 facing one side in the Y direction (a −Y direction side), an engagement surface 533 extending in the Y direction from the bottom 534 to face a −Z direction, and two guiding inclined surfaces 536 located with the bottom 534 sandwiched in the X direction in between.

The bottom 534 is configured to face the claw 422A in the Y direction. Further, the bottom 534 of the exemplary embodiment has such an area that the claw 422A is placeable therein. For instance, a dimension of the bottom 534 of the exemplary embodiment in the X direction is equal to dimensions of the claws 422A and 422B in the X direction. Further, in the exemplary embodiment, a dimension in the Y direction between the bottoms 534 of the recesses 532A, 532B is larger than a dimension of a clearance between the claws 422A and 422B.

The engagement surface 533 is engageable in the −Z direction with the claw 422A received in the recess 532A.

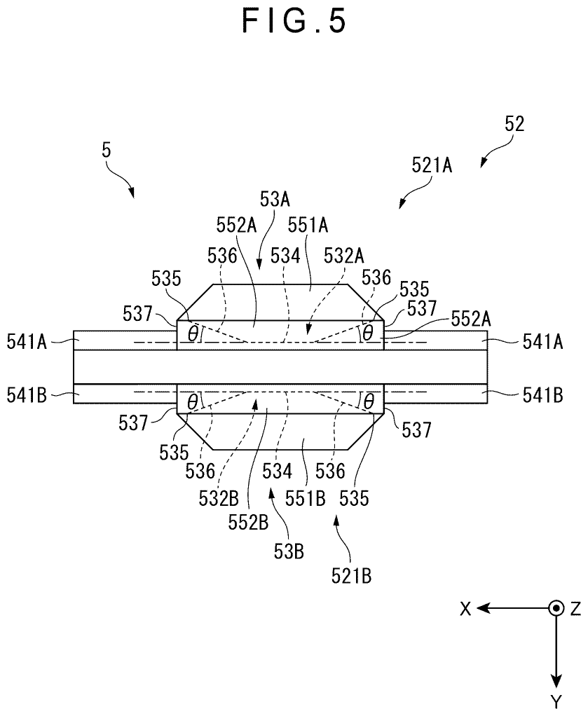

Each guiding inclined surface 536 faces the opening of the recess 532A and extends from the bottom 534 of the recess 532A to an edge 535 of the recess 532A adjacent to the disengagement guide 541A while inclined with respect to the X direction. Each guiding inclined surfaces 536 makes an inclination angle θ (see FIG. 5) with respect to the bottom 534.

The recess 532B, a part of which is not illustrated, has substantially a similar configuration to that of the above recess 532A. Specifically, the recess 532B has a bottom 534 facing the other side in the Y direction (a +Y direction side), an engagement surface 533 extending in the Y direction from the bottom 534 to face the +Z direction, and two guiding inclined surfaces 536 located with the bottom 534 sandwiched in the X direction in between.

Further, as illustrated in FIG. 5, the edge 535 of the recess 532A protrudes toward the −Y direction side beyond the disengagement guide 541A adjacent to the edge 535, whereas an edge 535 of the recess 532B protrudes toward the +Y direction side beyond the disengagement guide 541B adjacent to the edge 535. Steps are thus formed between the edge 535 and the disengagement guide 541A and between the edge 535 and the disengagement guide 541B and the steps form restricting surfaces 537 facing the respective disengagement guides 541A, 541B in the X direction.

As illustrated in FIG. 4 to FIG. 6, the disengagement guide 541A is formed in the lateral part 521A across a range from a position adjacent in the X direction to the engagement portion 53A to a distal end in the +Z direction. Likewise, the disengagement guide 541B is formed in the lateral part 521B across a range from a position adjacent in the X direction to the engagement portion 53B to a distal end in the +Z direction.

The ranges of the disengagement guides 541A and 541B in the Z-axis direction only have to extend at least from the positions adjacent in the X direction to the engagement portions 53A and 53B to the distal ends in the +Z direction, respectively. The ranges preferably extend in the +Z direction from positions on a −Z direction side with respect to the respective engagement surfaces 533 of the engagement portions 53A and 53B. The ranges of the disengagement guides 541A and 541B in the X direction are preferably comparable to or more than the dimensions of the claws 422A and 422B in the X direction, respectively. Further, the disengagement guides 541A and 541B each preferably have a flat planar shape without no large unevenness. Specifically, it is only necessary for the disengagement guides 541A and 541B to have, in the respective lateral parts 521A and 521B, areas with such a flatness that the body 52 is not inhibited from being pulled from between the pair of claws 422A and 422B.

Further, the disengagement guides 541A and 541B are inclined with respect to the Z direction. A dimension of the body 52 in the Y direction defined by the disengagement guides 541A and 541B gradually decreases toward the +Z direction. The disengagement guides 541A and 541B thus form a tapered shape together.

The body 52 further includes projections 551A and 551B projecting from the respective lateral parts 521A and 521B. In the exemplary embodiment, the projection 551A projects in the −Y direction from between the base 51 and the recess 532A and the projection 551B projects in the +Y direction from between the base 51 and the recess 532B.

Further, the body 52 includes engagement guides 552A and 552B formed, in the respective lateral parts 521A and 521B, on a +Z direction side (closer to the distal end in the extending direction) with respect to the respective recesses 532A and 532B. The engagement guides 552A and 552B are each in the form of a surface inclined to the Z direction. The dimension of the body 52 in the Y direction defined by the engagement guides 552A and 552B thus gradually decreases toward the +Z direction. The engagement guides 552A and 552B thus form a tapered shape together.

### Method of Using Cover Material Attachment 1

Description will be made on a method of using the cover material attachment 1 of the exemplary embodiment. In the following description, it is assumed that the clip engagement member 5 is attached to the cover material 3 and the clip 4 is attached in the groove 2A of the cushion material 2.

To engage the clip engagement member 5 with the clip 4, a worker first performs positioning of the clip engagement member 5 so that the clip engagement member 5 faces the clip 4 as illustrated in FIG. 1. At this time, the worker may identify positions of the engagement portions 53A and 53B of the clip engagement member 5 in the X direction by visually confirming the projection 551A (or the projection 551B) of the clip engagement member 5.

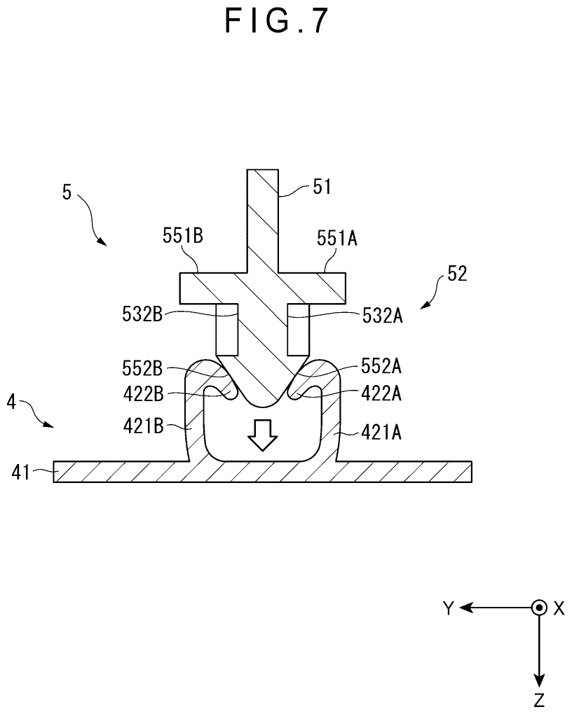

Subsequently, the worker applies force in the −Z direction to somewhere in the clip engagement member 5 (e.g., the projections 551A and 551B) to press the clip engagement member 5 against the clip 4 (see FIG. 7). This causes the body 52 (a range including the engagement portions 53A and 53B) of the clip engagement member 5 to be inserted into between the pair of claws 422A and 422B of the clip 4.

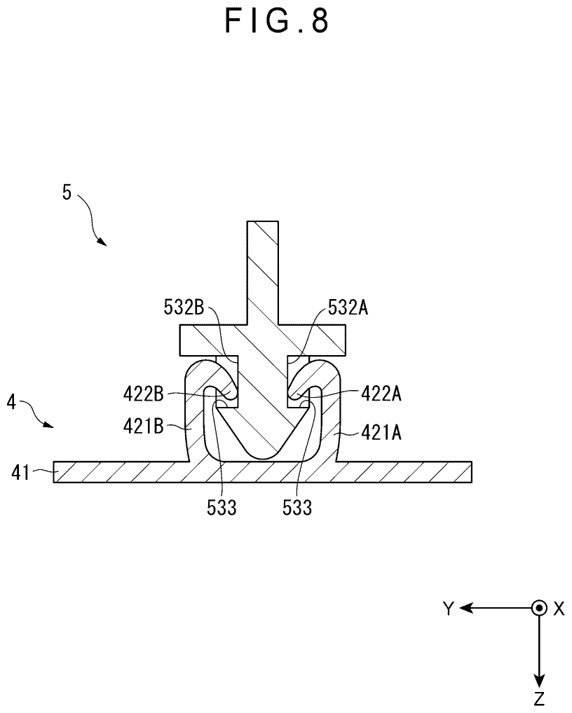

At this time, the claws 422A and 422B come into contact with the engagement guides 552A and 552B to be pressed outward in the Y direction by the engagement guides 552A and 552B, respectively. This causes the legs 421A and 421B to be elastically deformed with a distance in between increased. Then, when the claws 422A and 422B reach the recesses 532A and 532B to be received in the recesses 532A and 532B, respectively, the legs 421A and 421B are restored to the original shape (see FIG. 8). In this state, the claws 422A and 422B are contactable in the Z direction with the engagement surfaces 533 of the engagement portions 53A and 53B. The clip engagement member 5 can thus be engaged with the clip 4 to attach the cover material 3 to the cushion material 2.

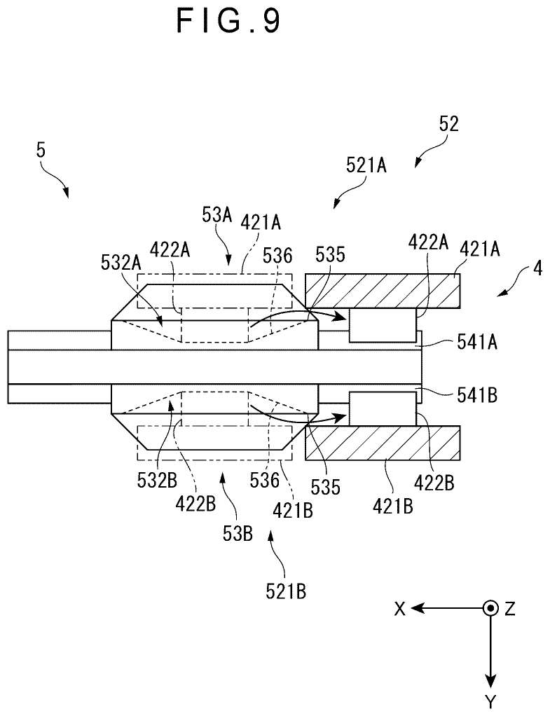

To disengage the clip 4 from the clip engagement member 5, the worker applies force, to the clip engagement member 5, toward either a positive side or a negative side in the X direction (e.g., in the +X direction). At this time, the claws 422A and 422B slide on the respective guiding inclined surfaces 536 of the recesses 532A and 532B and come out of the recesses 532A and 532B, as illustrated in FIG. 9 (corresponding to a first movement of the invention). Further, the worker has a click feeling when the claws 422A and 422B cross over the steps between the edges 535 of the recesses 532A, 532B and the disengagement guides 541A, 541B.

FIG. 9 schematically illustrates a position of the clip 4 relative to the clip engagement member 5, where positions of the legs 421A, 421B and the claws 422A, 422B of the clip 4 before the relative movement are indicated by broken lines and positions thereof after the relative movement are indicated by solid lines.

As the claws 422A and 422B come out of the recesses 532A and 532B, the engagement portions 53A and 53B come out from between the claws 422A and 422B, and the disengagement guides 541A and 541B come into between the pair of claws 422A and 422B.

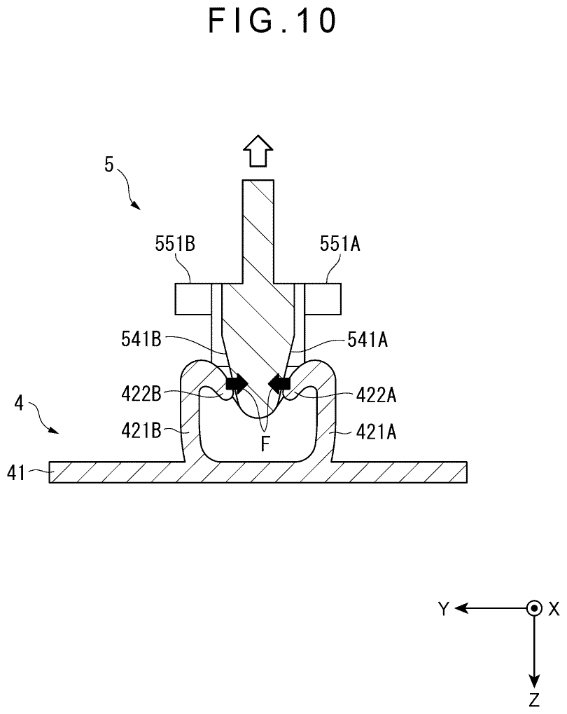

At this time, as illustrated in FIG. 10, the elastic force of the pair of legs 421A and 421B causes the pair of claws 422A and 422B to apply elastic force F inward in the Y direction to the disengagement guides 541A and 541B. The clip engagement member 5 then moves in the +Z direction to be pushed out from between the pair of claws 422A and 422B, being automatically separated from the clip 4 (corresponding to a second movement of the invention). The cover material 3 is thus removed from the cushion material 2.

### Effects

In the cover material attachment 1 of the exemplary embodiment, as described above, the claws 422A and 422B are movable from the engagement portions 53A and 53B to the disengagement guides 541A and 541B by the operation of moving the clip engagement member 5 in the X direction with respect to the clip 4. Then, the claws 422A and 422B are guided along the disengagement guides 541A and 541B by the operation of moving the clip engagement member 5 in the −Z direction with respect to the clip 4, making it possible to pull the body 52 from the clip 4. It is thus possible to disengage the clip engagement member 5 from the clip 4 without a component breakage or a complicated disengagement operation, facilitating the removal of the cover material 3 from the cushion material 2. This makes it possible to casually wash or replace the cover material 3 of the seat.

In the exemplary embodiment, the disengagement guides 541A and 541B respectively have planar shapes formed in the lateral parts 521A and 521B across the ranges from the positions adjacent in the X direction to the engagement portions 53A and 53B to the distal ends in the +Z direction, which makes it possible to favorably guide the claws 422A and 422B.

Further, the dimension of the body 52 in the Y direction defined by the disengagement guides 541A and 541B gradually decreases toward the +Z direction, which facilitates the operation of pulling the body 52 of the clip engagement member 5 from between the pair of legs 421A and 421B of the clip 4. In particular, the elastic force of the pair of legs 421A and 421B allows the clip engagement member 5 to be automatically separated from the clip 4 in the exemplary embodiment.

In the exemplary embodiment, the engagement portions 53A and 53B are respectively formed by the recesses 532A and 532B, and the claws 422A, 422B are respectively engaged with the engagement surfaces 533 of the engagement portions 53A and 53B by being received in the recesses 532A and 532B. This makes it possible to inhibit unintentional disengagement of the clip engagement member 5.

Further, the guiding inclined surfaces 536 are formed in the respective recesses 532A and 532B, allowing the claws 422A and 422B to easily come out of the recesses 532A and 532B by sliding the claws 422A and 422B on the guiding inclined surfaces 536 of the recesses 532A and 532B in disengagement of the clip engagement member 5 from the clip 4.

In the exemplary embodiment, the edges 535 of the recesses 532A and 532B protrude in the Y direction beyond the disengagement guides 541A and 541B adjacent to the edges 535, resulting in a click feeling when the claws 422A and 422B move from the edges 535 of the recesses 532A and 532B to the disengagement guides 541A and 541B.

In the exemplary embodiment, the dimension of the body 52 in the Y direction defined by the engagement guides 552A and 552B gradually decreases toward the +Z direction, which facilitates the operation of inserting the body 52 of the clip engagement member 5 into between the pair of legs 421A and 421B of the clip 4.

In the exemplary embodiment, the body 52 has the projections 551A and 551B projecting from the respective lateral parts 521A and 521B. The worker presses the projections 551A and 551B to achieve an easy operation on the clip engagement member 5. Further, when the projections 551A and 551B are placed on the +Z direction side of the recesses 532A and 532B, the positions of the recesses 532A and 532B in the X direction are easily identified by visually confirming the projections 551A and 551B.

In the exemplary embodiment, the single recess 532A and the two disengagement guides 541A are alternately formed in the X direction in the lateral part 521A, and the single recess 532B and the two disengagement guides 541B are alternately formed in the X direction in the lateral part 521B. Thus, in disengaging the clip engagement member 5 from the clip 4, the clip engagement member 5 may move toward either side in the X direction relative to the clip 4.

Further, in the exemplary embodiment, the respective two guiding inclined surfaces 536 are formed in the recesses 532A and 532B with the bottoms 534 of the recesses 532A and 532B sandwiched in the X direction in between. This allows the clip engagement member 5 to easily move toward either side in the X direction relative to the clip 4.

In the exemplary embodiment, the dimensions of the bottoms 534 of the recesses 532A and 532B in the X direction are equal to the dimensions of the claws 422A and 422B in the X direction, respectively. This makes it possible to inhibit the backlash of the clip engagement member 5 in the X direction relative to the clip 4.

### Modification Examples of First Exemplary Embodiment

In the first exemplary embodiment, the details of the recesses 532A and 532B are alterable.

For instance, it is possible to adjust the force required for disengagement by adjusting the inclination angle θ made between the guiding inclined surface 536 and the bottom 534 (see FIG. 5) to a desired angle. Further, it is possible to adjust the amount of the relative movement of the clip engagement member 5 in the X direction required for disengagement by adjusting the dimension of at least one of the guiding inclined surface 536 or the bottom 534 in the X direction.

Furthermore, in the first exemplary embodiment, the dimensions of the bottoms 534 of the recesses 532A and 532B in the X direction may be different from the dimensions of the claws 422A and 422B in the X direction, respectively.

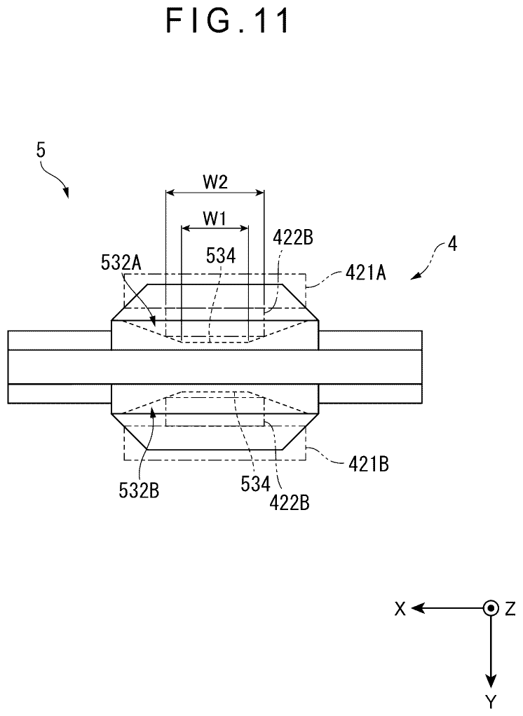

For instance, as illustrated in FIG. 11, a dimension W2 of the claws 422A and 422B in the X direction may be larger than a dimension W1 of the bottoms 534 of the recesses 532A and 532B in the X direction. Such a modification example enables fine adjustment of a posture of the clip engagement member 5 relative to the clip 4 in an XY-plane to enhance the flexibility of the cover material attachment 1 in the XY-plane.

Although the illustration is omitted, the dimensions of the claws 422A and 422B in the X direction may be smaller than the dimensions of the respective bottoms 534 in the X direction, respectively. Such a modification example enables fine adjustment of a position of the clip engagement member 5 in the X direction relative to the clip 4.

In the first exemplary embodiment, the two guiding inclined surfaces 536 are formed in each of the recesses 532A and 532B with the bottom 534 sandwiched in the X direction in between. As a modification example regarding the above, either one of the two guiding inclined surfaces 536 of the first exemplary embodiment may be formed in each of the recesses 532A and 532B.

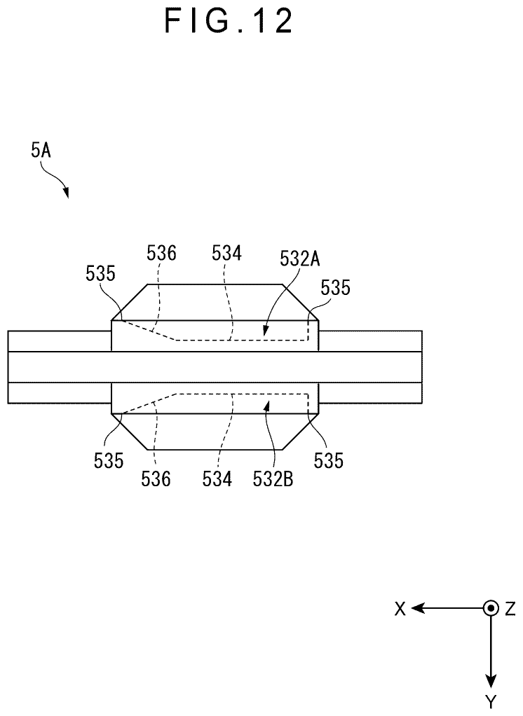

For instance, FIG. 12 illustrates a clip engagement member 5A according to a modification example of the first exemplary embodiment. As illustrated in FIG. 12, the guiding inclined surface 536 may be formed in each of the recesses 532A and 532B on one side in the X direction (+X direction side) relative to the bottom 534, and no guiding inclined surface 536 may be formed on the other side in the X direction (−X direction side) relative to the bottom 534 with the bottom 534 extending to the vicinity of the edge 535.

Although each of the guiding inclined surfaces 536 is connected to the whole of the range of the bottom 534 in the Z direction in the first exemplary embodiment, each of the guiding inclined surfaces 536 may be connected to a part of the range of the bottom 534 in the Z direction.

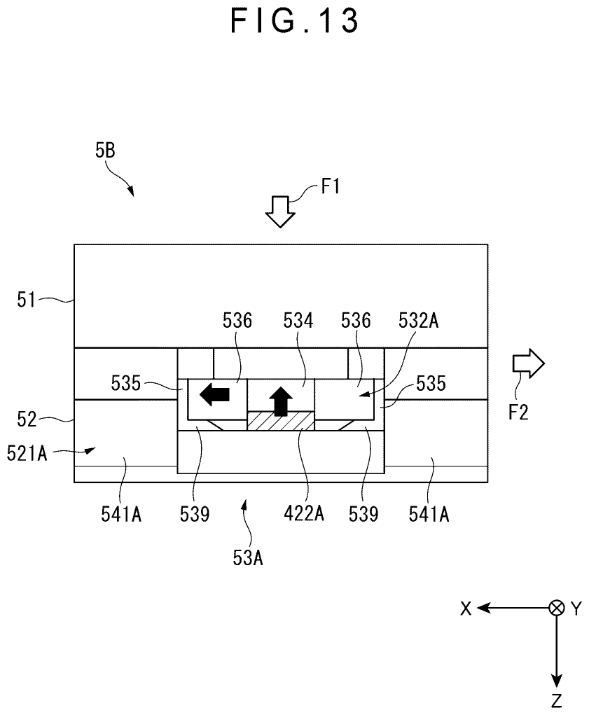

For instance, FIG. 13 illustrates a clip engagement member 5B according to another modification example of the first exemplary embodiment. It should be noted that in FIG. 13, a position of the claw 422A is schematically illustrated by hatching and a movement path of the claw 422A during disengagement is illustrated, by way of example, by black arrows.

In the clip engagement member 5B illustrated in FIG. 13, each guiding inclined surface 536 is connected to a part on the −Z direction side of the range of the bottom 534 in the Z direction. An elongated edge 539 continuous from the edge 535 is formed on the +Z direction side of the guiding inclined surface 536.

It is assumed that when the clip engagement member 5B and the clip 4 are engaged, the claw 422A is placed in a hatched range in FIG. 13 and faces a part on the +Z direction side of the range of the bottom 354 of the recess 532A in the Z direction. In this state, the claw 422A interferes with the elongated edge 539 in the X direction, so that the claw 422A is restrained from moving in the X direction without a change in the position in the Z direction. Although the illustration is omitted in FIG. 13, the same applies to the guiding inclined surfaces 536 of the recess 532B.

The worker applies force F1 toward the +Z direction and force F2 toward one of the sides in the X direction to the clip engagement member 5B together, thereby causing the clip engagement member 5B to slide as indicated by the black arrows in FIG. 13. This causes the claw 422A to reach the disengagement guide 541A through the guiding inclined surface 536, so that the clip engagement member 5B and the clip 4 can be disengaged.

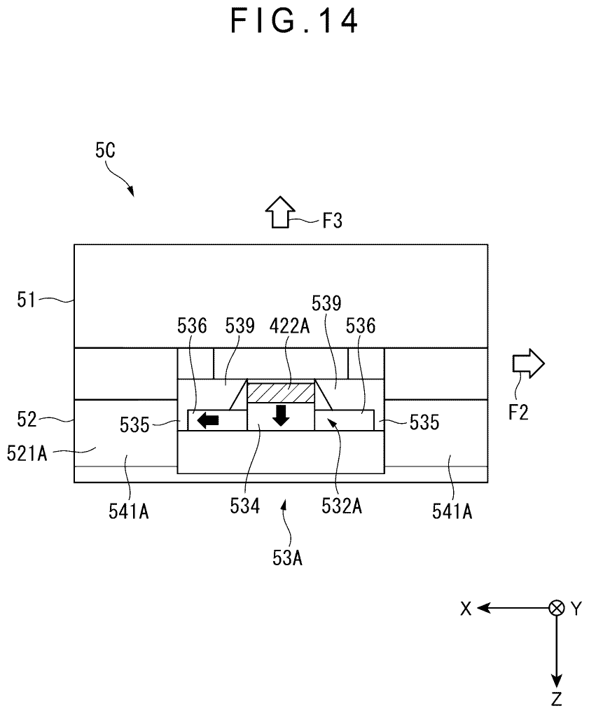

FIG. 14 illustrates a clip engagement member 5C according to still another modification example of the first exemplary embodiment. It should be noted that in FIG. 14, a position of the claw 422A is schematically illustrated by hatching and a movement path of the claw 422A during disengagement is illustrated, by way of example, by black arrows.

In the clip engagement member 5C illustrated in FIG. 14, each guiding inclined surface 536 is connected to a part on the +Z direction side of the range of the bottom 534 in the Z direction. The elongated edge 539 continuous from the edge 535 is formed on the −Z direction side of the guiding inclined surface 536.

It is assumed that when the clip engagement member 5B and the clip 4 are engaged, the claw 422A is placed in a hatched range in FIG. 14 and faces a part on the −Z direction side of the range of the bottom 354 of the recess 532A in the Z direction. In this state, the claw 422A interferes with the elongated edge 539 in the X direction, so that the claw 422A is restrained from moving in the X direction without a change in the position in the Z direction. Although the illustration is omitted in FIG. 14, the same applies to the guiding inclined surfaces 536 of the recess 532B.

The worker applies force F3 toward the −Z direction and force F2 toward one of the sides in the X direction to the clip engagement member 5B together, thereby causing the clip engagement member 5C to slide as indicated by the black arrows in FIG. 14. This causes the claw 422A to reach the disengagement guide 541A through the guiding inclined surface 536, so that the clip engagement member 5C and the clip 4 can be disengaged.

In the modification examples as illustrated in FIGS. 13 and 14, it is possible to inhibit the unintentional disengagement of the clip engagement members 5B, 5C and the clip 4. The elongated edge 539 may have a guiding inclined surface to guide the claw 422A (or the claw 422B) toward the guiding inclined surface 536.

Although the pair of projections 551A and 551B is provided in the first exemplary embodiment, either one of the projections 551A and 551B may be provided while the other thereof may be omitted, or none of the projections 551A, 551B may be provided.

Further, although the projections 551A and 551B project from between the base 51 and the recesses 532A, 532B in the first exemplary embodiment, the projections 551A and 551B may project from between the base 51 and the disengagement guides 541A, 541B.

Although the disengagement guides 541A are located in the body 52 on both sides in the X direction relative to the engagement portion 53A in the first exemplary embodiment, the disengagement guide 541A may be formed on one side in the X direction relative to the engagement portion 53A while no disengagement guide 541A may be formed on the other side in the X direction. The same applies to the disengagement guide 541B.

Further, in the first exemplary embodiment, the disengagement guides 541A and 541B do not necessarily form a tapered shape. For instance, the thickness of the body 52 between the disengagement guides 541A and 541B only has to be such a thickness to be insertable in between the pair of claws 422A and 422B.

In the first exemplary embodiment, the operation of moving the clip engagement member 5 is described as follows: the claws 422A and 422B reach the engagement portions 53A and 53B through the engagement guides 552A and 552B in engaging the clip 4 and the clip engagement member 5. The invention, however, is not limited thereto.

For instance, an operation on the clip engagement member 5 may be performed as follows: force in the Z-direction and force in the X direction are applied in sequence to the clip engagement member 5 to cause the claws 422A and 422B to reach the engagement portions 53A and 53B through the disengagement guides 541A and 541B.

Further, the cushion material 2 in which the clip 4 is installed may be moved instead of the clip engagement member 5.

### Second Exemplary Embodiment

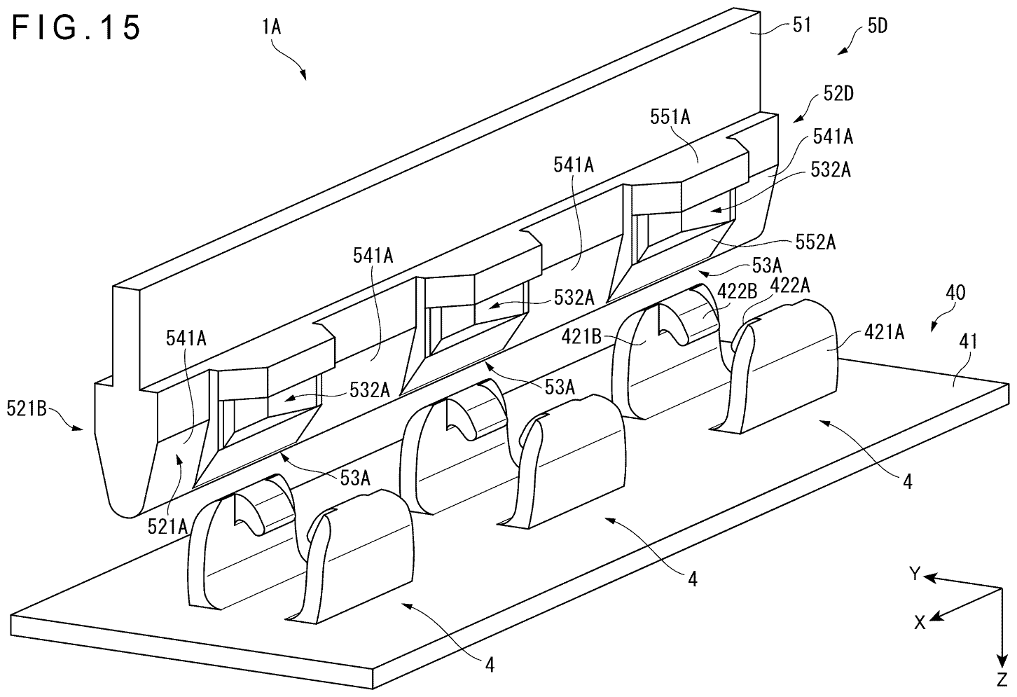

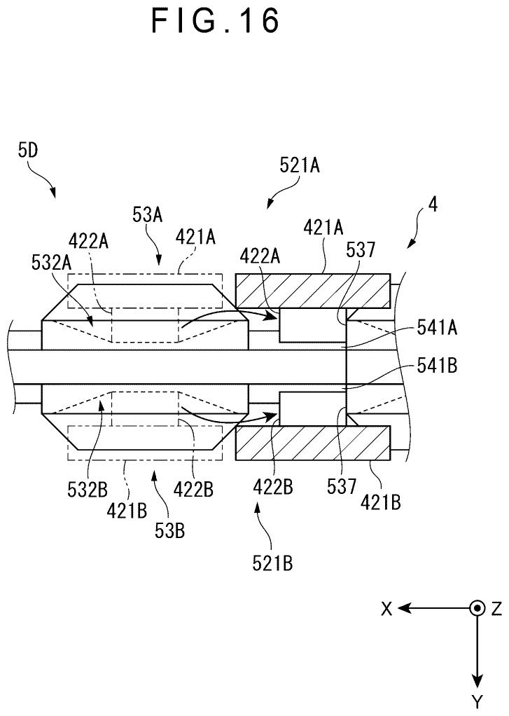

Referring to FIGS. 15 to 16, description will be made on a cover material attachment 1A according to a second exemplary embodiment of the invention. The cover material attachment 1A of the exemplary embodiment includes a clip assembly 40 including a plurality of integrally formed clips 4 and a clip engagement member 5D including a plurality of engagement portions 53A and a plurality of engagement portions 53B.

The clips 4 of the clip assembly 40 are arranged at intervals in the X direction. Further, a single base 41 is shared among the clips 4.

The clip engagement member 5D includes a base 51 and a body 52D extending in the Z direction from the base 51. The body 52D includes a pair of lateral parts 521A and 521B facing opposite sides in the Y direction to each other.

In the exemplary embodiment, the plurality of engagement portions 53A and a plurality of disengagement guides 541A are alternately formed in the X direction in the lateral part 521A, and the plurality of engagement portions 53B and a plurality of disengagement guides 541B are alternately formed in the X direction in the lateral part 521B. The engagement portions 53A, 53B and the disengagement guides 541A, 541B are configured similarly to those of the first exemplary embodiment.

The number of the clips 4 of the clip assembly 40 and the number of the engagement portions 53A and 53B of the clip engagement member 5D are not limited to those illustrated by way of example in the drawings. Further, the number of the clips 4 of the clip assembly 40 and the number of the engagement portions 53A and 53B of the clip engagement member 5D are not necessarily the same.

Furthermore, the engagement portions 53A and 53B of the clip engagement member 5D arranged in a front-and-back relationship are paired and the engagement portions 53A and 53B as the pair are engageable with the corresponding one of the clips 4. Pitches between the clips 4 of the clip assembly 40 are preferably equal to or a multiple of pitches between the pairs of engagement portions 53A and 53B of the clip engagement member 5D.

In the exemplary embodiment, engagement and disengagement between the clip assembly 40 and the clip engagement member 5D, that is, engagement and disengagement between the clip 4 and the engagement portions 53A and 53B corresponding thereto are performed by an operation similar to that of the first exemplary embodiment.

For instance, to disengage the clip assembly 40 from the clip engagement member 5, the worker applies force, to the clip engagement member 5, toward either a positive side or a negative side in the X direction (e.g., in the +X direction). Here, if the force applied by the worker is excessive, a sliding amount of the clip engagement member 5D may be larger than a necessary amount, as illustrated in FIG. 16. In such a case, the claws 422A and 422B approach another engagement portions 53A and 53B located adjacent to the engagement portions 53A and 53B that were engaged with the claws 422A and 422B, and the claws 422A and 422B come into contact with restricting surfaces 537 of the another engagement portions 53A and 53B in the X direction. This stops the excessive sliding of the clip engagement member 5D.

FIG. 16 schematically illustrates a position of one of the clips 4 relative to the clip engagement member 5D, where positions of the legs 421A, 421B and the claws 422A, 422B of the clip 4 before the relative movement are indicated by broken lines and positions thereof after the relative movement are indicated by solid lines.

The cover material attachment 1A of the second exemplary embodiment described above produces effects similar to those of the first exemplary embodiment. Further, in the cover material attachment 1A of the exemplary embodiment, it is possible to inhibit the excessive sliding of the clip engagement member 5D and to avoid engagement of the claws 422A and 422B with the another engagement portions 53A and 53B.

### Modification Examples of Second Exemplary Embodiment

The clip assembly 40 or the clip engagement member 5D of the second exemplary embodiment may further include a protruding structure to inhibit the excessive sliding.

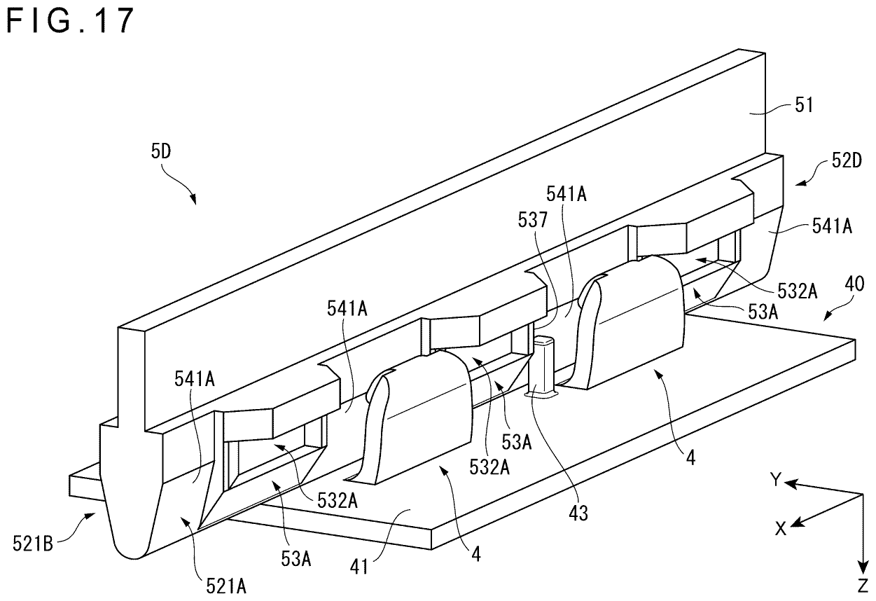

For instance, FIG. 17 illustrates the clip assembly 40 according to a modification example of the second exemplary embodiment. As illustrated in FIG. 17, the clip assembly 40 includes at least one restricting protrusion 43 (a clip restricting protrusion) provided on the base 41. The restricting protrusion 43 is located between adjacent two of the clips 4 and protrudes in the −Z direction from the base 41. In this modification example, when the sliding amount of the clip engagement member 5D is larger than the necessary amount, the restricting surface 537 of one of the engagement portions 53A and 53B comes into contact with the restricting protrusion 43 before coming into contact with the claw 422A (or the claw 422B). This makes it possible to more favorably inhibit the excessive sliding of the clip engagement member 5D.

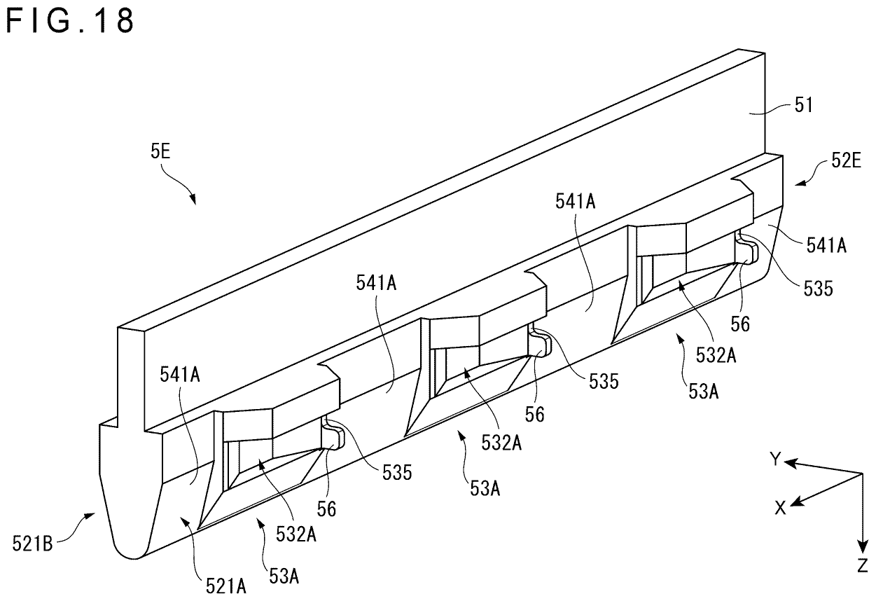

FIG. 18 illustrates a clip engagement member 5E according to another modification example of the second exemplary embodiment. As illustrated in FIG. 18, a body 52E of the clip engagement member 5E includes a restricting protrusion 56 that is provided on one side of each of the engagement portions 53A in the X direction (i.e., on the edge 535 of the recess 532A on one side in the X direction) and that protrudes on one side in the Y direction (e.g., on the −Y direction side).

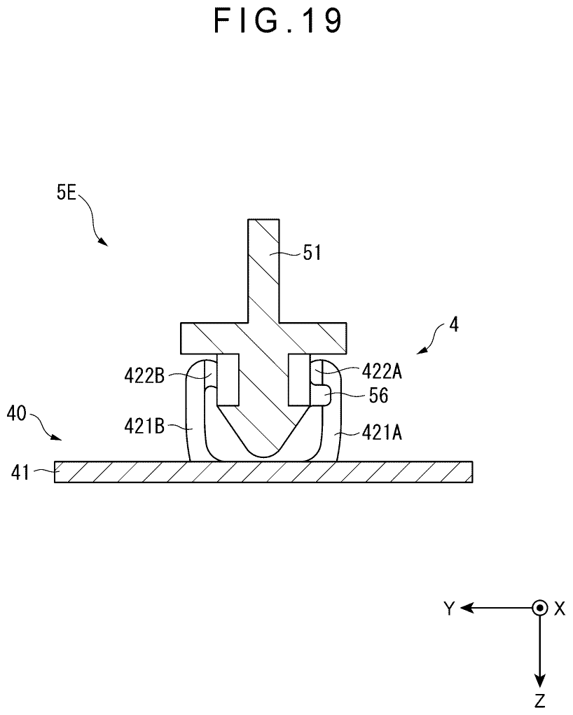

In this modification example, when the sliding amount of the clip engagement member 5E is larger than the necessary amount, the leg 421A of each of the clips 4 is capable of coming into contact with the restricting protrusion 56 of another engagement portion 53A adjacent in the X direction to the corresponding engagement portion 53A (see FIG. 19). This makes it possible to more favorably inhibit the excessive sliding of the clip engagement member 5E.

Although the restricting protrusions 56 are provided corresponding one-to-one to the engagement portions 53A in the example of FIG. 18, at least one restricting protrusion 56 may be provided for the body 52E. Further, the restricting protrusions 56 may be provided corresponding one-to-one to the engagement portions 53B in place of the engagement portions 53A or in addition to the engagement portions 53A.

In the second exemplary embodiment, the pitches between the clips 4 of the clip assembly 40 and the pitches between the engagement portions 53A, 53B of the clip engagement member 5D may be individually set as desired.

For instance, reducing the pitches between the engagement portions 53A, 53B of the clip engagement member 5D improves attachment strength. In contrast, increasing the pitches between the engagement portions 53A, 53B of the clip engagement member 5D makes it easy for the clip engagement member 5D to curve along a curve on the XY-plane. This makes it possible to improve conformability with the curve of the groove 2A of the cushion material 2. Further, the pitches of the engagement portions 53A, 53B of the clip engagement member 5D may include pitches different from each other.

In the above second exemplary embodiment, no restricting surface 537 may be provided in the engagement portions 53A and 53B. In this case, the engagement portions 53A and 53B may be engaged with another clip 4 located adjacent to the clip 4 that was engaged with the engagement portions 53A and 53B by causing the clip engagement member 5D to slide in the X direction.

In addition to the above, the modification examples described in the first exemplary embodiment are applicable to the second exemplary embodiment.

### Third Exemplary Embodiment

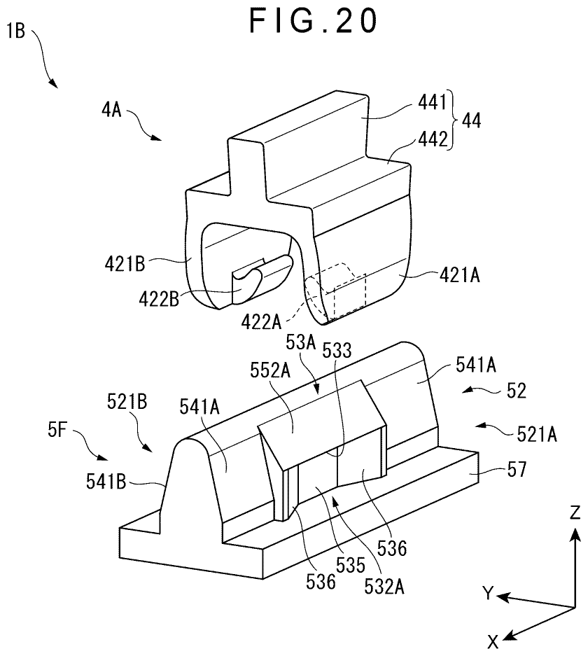

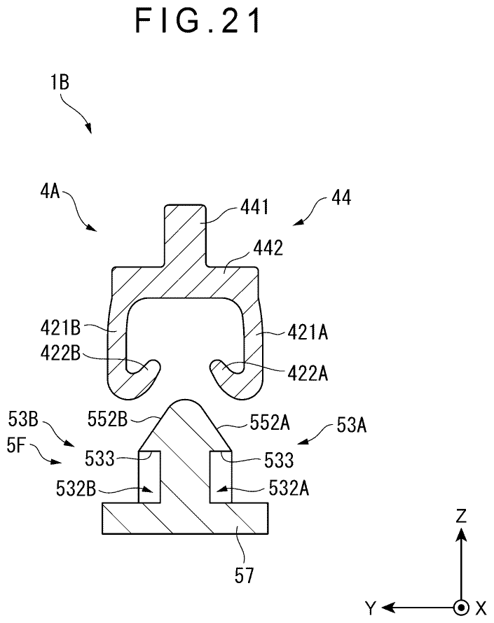

Referring to FIGS. 20 to 21, description will be made on a cover material attachment 1B according to a third exemplary embodiment of the invention.

The cover material attachment 1B of the exemplary embodiment is different from the first exemplary embodiment in a combination of a clip 4A and a clip engagement member 5F for the cushion material 2 and the cover material 3 (see FIG. 1). Specifically, the cover material attachment 1B of the third exemplary embodiment includes the clip engagement member 5F to be located in the groove 2A of the cushion material 2 and the clip 4A to be attached to the cover material 3.

It should be noted that respective basic configurations of the clip 4A and the clip engagement member 5F of the exemplary embodiment are similar to those of the first exemplary embodiment. In the following, description will be made mainly on configurations different from those of the first exemplary embodiment.

The clip 4A includes a base 44, a pair of legs 421A and 421B provided for the base 44, and a pair of claws 422A and 422B provided for the pair of legs 421A and 421B and facing each other.

The base 44 includes a tape 441 and a plate 442 connected to the tape 441. The tape 441 is to be fixed to the cover material 3 by means of sewing or the like.

The clip 4A may be integrally molded from a resin or the like. Alternatively, the tape 441 provided by unwoven fabric or the like may be insert-molded with respect to a different portion of the clip 4A.

The clip engagement member 5F includes a base 57 and a body 52 extending in the Z direction from the base 57. In the exemplary embodiment, an extending direction of the body 52 of the clip engagement member 5F is the Z direction as in the first exemplary embodiment.

The base 57 of the exemplary embodiment has, for instance, a plate shape and to be bonded to a bottom of the groove 2A (see FIG. 1) of the cushion material 2. In the exemplary embodiment, the positive and negative sides of the Z direction in FIG. 1 are inverted.

The body 52 includes a pair of lateral parts 521A and 521B facing opposite sides in the Y direction to each other, engagement portions 53A and 53B formed in the respective lateral parts 521A and 521B, and disengagement guides 541A and 541B formed in the respective lateral parts 521A and 521B, as in the first exemplary embodiment.

In the exemplary embodiment, the clip 4A and the clip engagement member 5F are engageable and disengageable by an operation substantially the same as that of the first exemplary embodiment.

For instance, to engage the clip 4A with the clip engagement member 5F, a worker performs positioning of the clip 4A so that the clip 4A faces the clip engagement member 5F and applies force in the −Z direction to somewhere in the clip 4A (e.g., the plate 442) to press the clip 4A against the clip engagement member 5F. The claws 422A and 422B are received in the recesses 532A and 532B through the engagement guides 552A and 552B to be contactable with respective engagement surfaces 533 of the engagement portions 53A and 53B. The clip 4A is thus engaged with the clip engagement member 5F to attach the cover material 3 to the cushion material 2.

To disengage the clip 4A from the clip engagement member 5F, the worker applies force, to the clip 4A, toward the positive side or the negative side in the X direction. At this time, the claws 422A and 422B slide on the respective guiding inclined surfaces 536 of the recesses 532A and 532B, and come out of the recesses 532A and 532B. The engagement portions 53A and 53B thus come out from between the claws 422A and 422B, and the disengagement guides 541A and 541B come into between the pair of claws 422A and 422B.

Then, the elastic force of the pair of legs 421A and 421B causes the clip 4A to move in the +Z direction to push out the body 52 from between the pair of claws 422A, 422B, so that the clip 4A is automatically separated from the clip engagement member 5F. The cover material 3 is thus removed from the cushion material 2.

The cover material attachment 1B of the third exemplary embodiment described above produces effects similar to those of the first exemplary embodiment.

As a modification example of the exemplary embodiment, a plurality of clips 4A may form a clip assembly as in the second exemplary embodiment. Further, in the clip engagement member 5F, a plurality of recesses 532A and a plurality of disengagement guides 541A may be alternately arranged in the X direction in the lateral part 521A, and a plurality of recesses 532B and a plurality of disengagement guides 541B may be alternately arranged in the X direction in the lateral part 521B.

The modification examples described in the first and second exemplary embodiments are also applicable to the third exemplary embodiment.

### Fourth Exemplary Embodiment

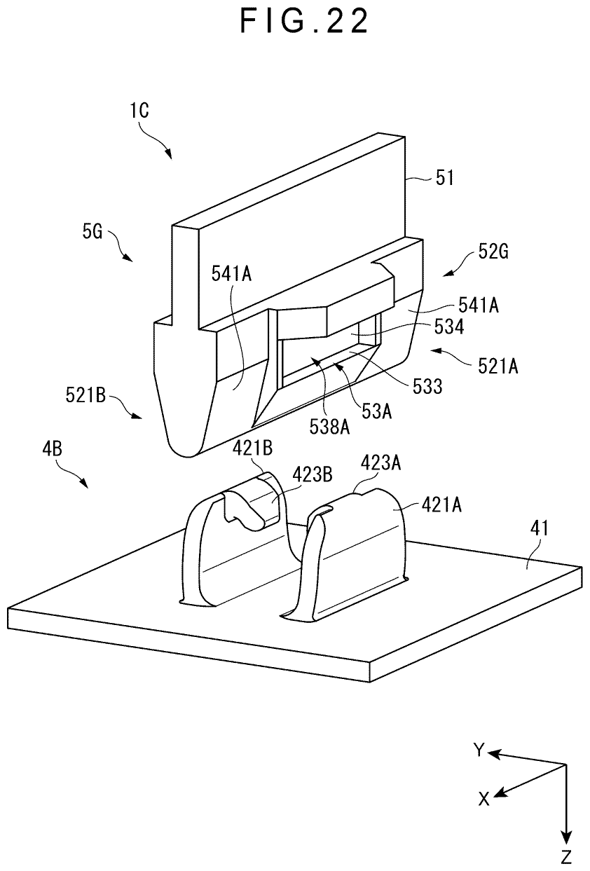

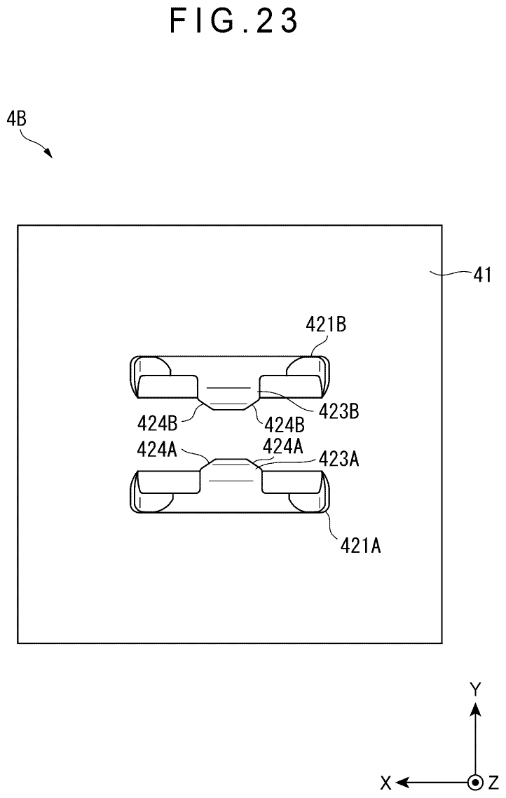

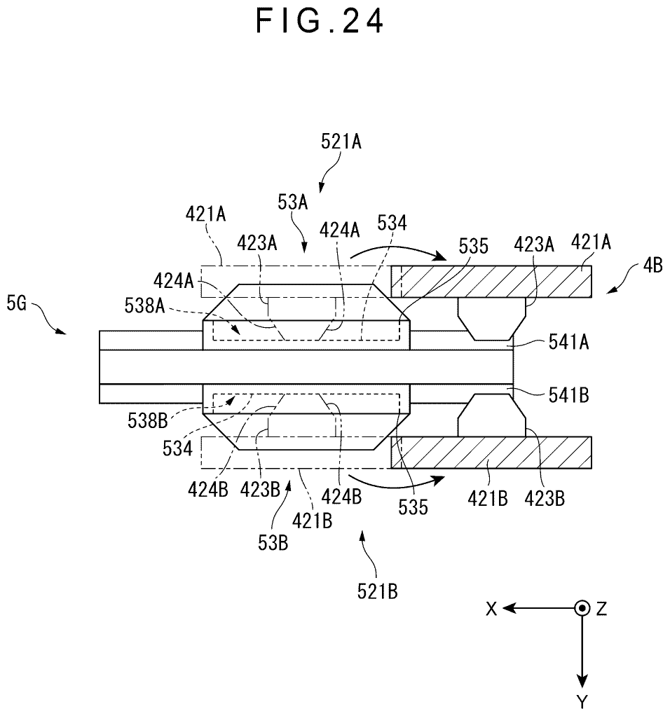

Referring to FIGS. 22 to 24, description will be made on a cover material attachment 1C according to a fourth exemplary embodiment of the invention. The cover material attachment 1C of the exemplary embodiment includes a clip 4B and a clip engagement member 5G. Although the clip engagement member 5G does not have the guiding inclined surfaces as in the first to third exemplary embodiments, the clip 4B has guiding inclined surfaces 424A and 424B (claw guiding inclined surfaces) (see, FIG. 23 and FIG. 24).

It should be noted that respective basic configurations of the clip 4B and the clip engagement member 5G of the exemplary embodiment are similar to those of the first exemplary embodiment. In the following, description will be made mainly on configurations different from those of the first exemplary embodiment.

The clip 4B includes a base 41, a pair of legs 421A and 421B provided for the base 41, and a pair of claws 423A and 423B provided for the pair of legs 421A and 421B and facing each other. As illustrated in FIG. 23, the claw 423A has a pair of guiding inclined surfaces 424A in a form such as chamfered corners of a distal end of the claw 423A. Likewise, the claw 423B has a pair of guiding inclined surfaces 424B in a form such as chamfered corners of a distal end of the claw 423B.

The guiding inclined surfaces 424A of the claw 423A are inclined to the X direction while facing a bottom 534 of a later-described recess 538A and facing edges 535 of the recess 538A adjacent to the disengagement guides 541A.

Likewise, the guiding inclined surfaces 424B of the claw 423B are inclined to the X direction while facing the bottom 534 of a later-described recess 538B and facing edges 535 of the recess 538B adjacent to the disengagement guides 541B.

The clip engagement member 5G includes a base 51 and a body 52G extending from the base 51. The body 52G includes a pair of lateral parts 521A and 521B facing opposite sides in the Y direction to each other, engagement portions 53A and 53B formed in the respective lateral parts 521A and 521B, and disengagement guides 541A and 541B formed in the respective lateral parts 521A and 521B.

In the exemplary embodiment, recesses 538A and 538B are formed to open in the respective lateral parts 521A and 521B. The engagement portions 53A and 53B of the exemplary embodiment include engagement surfaces 533 formed in the recesses 538A and 538B of the lateral parts 521A and 521B.

The recesses 538A and 538B are the same as those of the first exemplary embodiment except that no guiding inclined surface is provided. Specifically, the recesses 538A and 538B each have the bottom 534 facing the −Y direction side and the engagement surface 533 extending in the Y direction from the bottom 534 to face the +Z direction. Although not particularly limited, for instance, surfaces vertical to the X direction are respectively formed between the bottom 534 and the edges 535 in each of the recesses 538A and 538B.

In the exemplary embodiment, the clip 4B and the clip engagement member 5G are engageable and disengageable by an operation substantially the same as that of the first exemplary embodiment.

For instance, to disengage the clip 4B from the clip engagement member 5G, the worker applies force, to the clip engagement member 5G, toward either the positive side or the negative side in the X direction (e.g., the +X direction). At this time, the guiding inclined surfaces 424A and 424B on the −X direction side of the claws 423A and 423B slide on the edges 535 on the −X direction side of the recesses 538A and 538B and come out of the recesses 538A and 538B, as illustrated in FIG. 24.

FIG. 24 schematically illustrates a position of the clip 4B relative to the clip engagement member 5G, where positions of the legs 421A, 421B and the claws 423A, 423B of the clip 4B before the relative movement are indicated by broken lines and positions thereof after the relative movement are indicated by solid lines.

After the claws 423A and 423B come out of the recesses 538A and 538B, the clip engagement member 5G is separated from the clip 4B as in the first exemplary embodiment.

The cover material attachment 1C of the fourth exemplary embodiment described above produces effects similar to those of the first exemplary embodiment.

Further, the two guiding inclined surfaces 424A are formed in the claw 423A and the two guiding inclined surfaces 424B are formed in the claw 422B in the exemplary embodiment. Thus, to disengage the clip 4B from the clip engagement member 5G, the worker only has to slide the clip engagement member 5G toward either the positive side or the negative side in the X direction.

The modification examples described in the first to third exemplary embodiments are also applicable to the fourth exemplary embodiment.

For instance, in the exemplary embodiment, a plurality of clips 4B may form a clip assembly and the clip engagement member 5G may include a plurality of engagement portions 53A, a plurality of engagement portions 53B, a plurality of disengagement guides 541A alternately arranged in the X direction with respect to the engagement portions 53A, and a plurality of disengagement guides 541B alternately arranged in the X direction with respect to the engagement portions 53B, as in the second exemplary embodiment.

Further, the guiding inclined surfaces 424A and 424B may be respectively formed in the claws 423A and 423B on only one of the sides in the X direction.

### Fifth Exemplary Embodiment

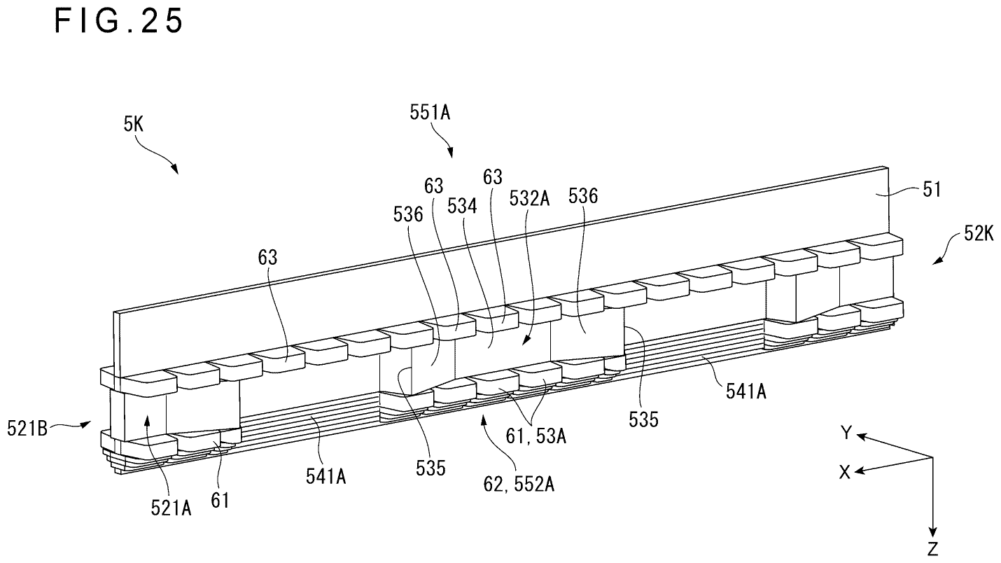

Referring to FIGS. 25 to 27, description will be made on a cover material attachment according to a fifth exemplary embodiment of the invention.

The cover material attachment of the exemplary embodiment includes a clip engagement member 5K in a different shape from that of the first exemplary embodiment and a clip 4 similar to that of the first exemplary embodiment. Description will be made below on the clip engagement member 5K.

The clip engagement member 5K includes a base 51 similar to that of the first exemplary embodiment and a body 52K extending in the +Z direction from the base 51. The body 52K includes a pair of lateral parts 521A and 521B facing opposite sides in the Y direction to each other.

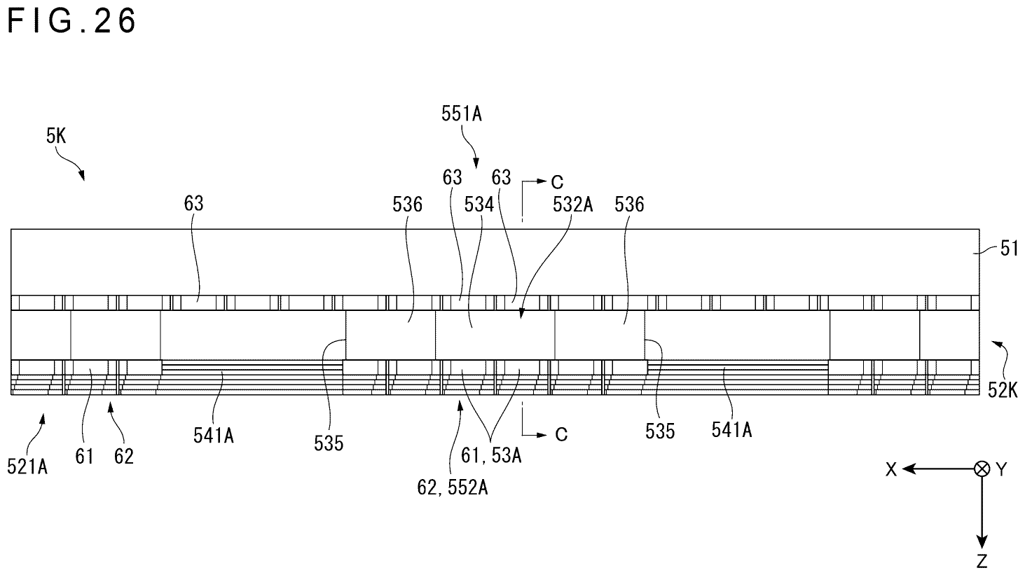

FIG. 25 and FIG. 26 each illustrate the lateral part 521A out of the pair of lateral parts 521A and 521B. In this regard, the pair of lateral parts 521A and 521B in the exemplary embodiment are plane symmetry with respect to an XZ-plane.

The lateral part 521A has a recess 532A opened therein and the lateral part 521B has a recess 532B opened therein. The recesses 532A and 532B each have a bottom 534 and two guiding inclined surfaces 536 located with the bottom 534 sandwiched in the X direction in between. The guiding inclined surfaces 536 extend from the bottoms 534 to edges 535 of each of the recesses 532A and 532B while inclined with respect to the X direction.

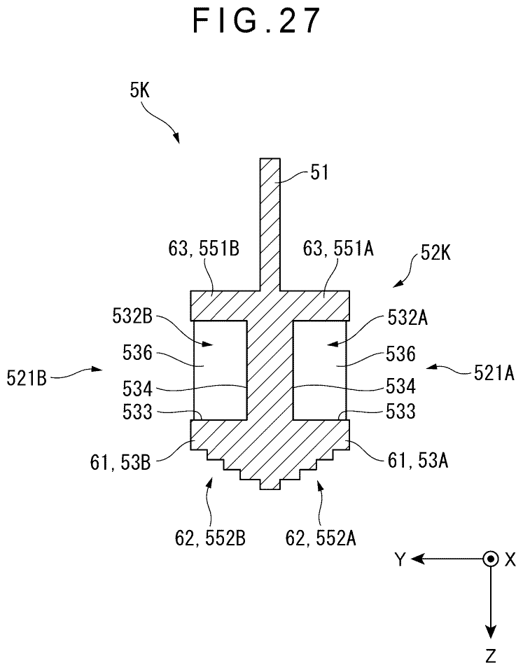

Further, each of the lateral parts 521A and 521B of the exemplary embodiment includes a plurality of protrusions 61 arranged in the X direction. The protrusions 61 are located on the +Z side of the recesses 532A and 532B and protrude in the Y direction beyond the bottoms 534 of the recesses 532A and 532B. The protrusions 61 serve as the engagement portions 53A and 53B of the exemplary embodiment (see FIG. 27).

It should be noted that a protruding level of the protrusions 61 in the Y direction is the same as or lower than that of the edges 535 of the recesses 532A and 532B.

Each of the lateral parts 521A and 521B of the exemplary embodiment includes a plurality of stepped portions 62, which have a stepped shape directed inward in the Y direction toward the +Z side from the protrusions 61. Each of the stepped portions 62 is arranged corresponding one-to-one to each of the protrusions 61. The stepped portions 62 serve as engagement guides 552A and 552B of the exemplary embodiment (see FIG. 27).

Further, disengagement guides 541A and 541B of the exemplary embodiment are each in a flat shape arranged along the XZ-plane.

Further, each of the lateral parts 521A and 521B of the exemplary embodiment includes a plurality of protrusions 63 arranged in the X direction. The protrusions 63 are located on the −Z side of the recesses 532A and 532B and protrude in the Y direction beyond the bottoms 534 of the recesses 532A and 532B. Each of the protrusions 63 serves as a projection of the exemplary embodiment.

In the exemplary embodiment described above, the clip 4 and the clip engagement member 5K are engageable and disengageable by an operation substantially the same as that of the first exemplary embodiment.

In the exemplary embodiment, none of the engagement guides 552A, 552B and the disengagement guides 541A, 541B has an inclined surface inclined to the Z direction. That is, the engagement guides 552A and 552B have a stepped shape and the disengagement guides 541A and 541B have a flat shape, making it possible to reduce costs for a mold to form the clip engagement member 5K.

Specifically, a manufacturing device that forms the clip engagement member 5K made from a resin includes a pair of rollers. The clip engagement member 5K is continuously integrally-molded by injecting the resin into between the pair of rolls. Here, the rollers are rotary molds including a plurality of stacked plates, and a rotation axis direction of each of the rollers corresponds to the Z direction of the clip engagement member 5K.

Assuming that the above manufacturing device is used to manufacture the clip engagement member 5 of the first exemplary embodiment, a plate having a large thickness in the rotation axis direction is needed as a plate that enables inclined surfaces inclined to the Z direction (e.g., the engagement guides 552A, 552B and the disengagement guides 541A, 541B) to be formed in the clip engagement member 5. Manufacturing such a plate requires multiaxial cutting work, and it costs a lot to replace the broken plate.

In contrast, in the clip engagement member 5K of the exemplary embodiment, none of the engagement guides 552A, 552B and the disengagement guides 541A, 541B has an inclined surface inclined to the Z direction. Thus, in a case where the above manufacturing device is used to manufacture the clip engagement member 5K of the exemplary embodiment, the thickness of each of the plates forming the rollers is reducible. Since such a plate is manufacturable by wire electrical discharge machining, the replacement cost of the broken plate is inexpensive.

In the exemplary embodiment, each of the engagement portions 53A and 53B includes the protrusions 61 arranged in the X direction, and each of the engagement guides 552A and 552B includes the stepped portions 62 arranged in the X direction. That is, the clip engagement member 5K of the exemplary embodiment includes the components protruding in the Y direction that are formed intermittently in the X direction. In such an arrangement, in a case where the groove 2A of the cushion material 2 has a curved shape, the clip engagement member 5K is likely to be curved and easily inserted into the groove 2A.

As a modification example of the clip engagement member 5K of the exemplary embodiment, a plurality of recesses 532A and a plurality of disengagement guides 541A may be alternately arranged in the X direction in the lateral part 521A, and a plurality of recesses 532B and a plurality of disengagement guides 541B may be alternately arranged in the X direction in the lateral part 521B, as in the second exemplary embodiment. In other words, the configuration of the clip engagement member 5K illustrated in FIG. 25 and FIG. 26 may be thought of as a partial configuration in the X direction.

As another modification example of the exemplary embodiment, each of the engagement portions 53A and 53B may include a single protrusion 61. Likewise, each of the engagement guides 552A and 552B may include a single stepped portion 62.

Further, modification examples described in the other exemplary embodiments described above are also applicable to the exemplary embodiment.

### Other Modification Examples

In the first to third exemplary embodiments and the fifth exemplary embodiment, the description is made on the configuration where the guiding inclined surfaces 536 are formed in the recesses 532A and 532B of the clip engagement members 5, 5A to 5F, and 5K, and in the fourth exemplary embodiment, the description is made on the configuration where the guiding inclined surfaces 424A and 424B are formed in the claws 423A and 423B of the clip 4B. The invention, however, is not limited thereto.

For instance, in the first to third exemplary embodiments and the fifth exemplary embodiment, in addition to or in place of the formation of the guiding inclined surfaces 536 in the clip engagement members 5, 5A to 5F, and 5K, the guiding inclined surfaces as in the fourth exemplary embodiment may be formed in the clips 4 and 4A.

Alternatively, in each of the exemplary embodiments, none of the guiding inclined surfaces 536, 424A, and 424B may be formed. For instance, a small step may be provided between the bottom 534 of the recess 532A and each of the edges 535 of the recess 532A adjacent to the disengagement guide 541A and a small step may be provided between the bottom 534 of the recess 532B and each of the edges 535 of the recess 532B adjacent to the disengagement guide 541B, so that it is possible for the claws 422A and 422B to climb onto the disengagement guides 541A and 541B from the recesses 532A and 532B by force caused by a user's operation.

In the above exemplary embodiments, the recesses 532A and 532B are respectively provided for the lateral parts 521A and 521B, and the engagement portions 53A and 53B include the engagement surfaces 533 formed in the respective recesses 532A and 532B. The invention, however, is not limited thereto.

For instance, no recesses 532A and 532B may be provided for the lateral parts 521A and 521B. Protrusions protruding from the lateral parts 521A and 521B may be formed as the engagement portions 53A and 53B and side surfaces of the protrusions may be formed as the engagement surfaces 533.

In the above exemplary embodiments, the clips 4, 4A, 4B and the clip engagement members 5, 5A to 5G, 5K each have a plane-symmetrical shape with respect to the XZ-plane. The invention, however, is not limited thereto.

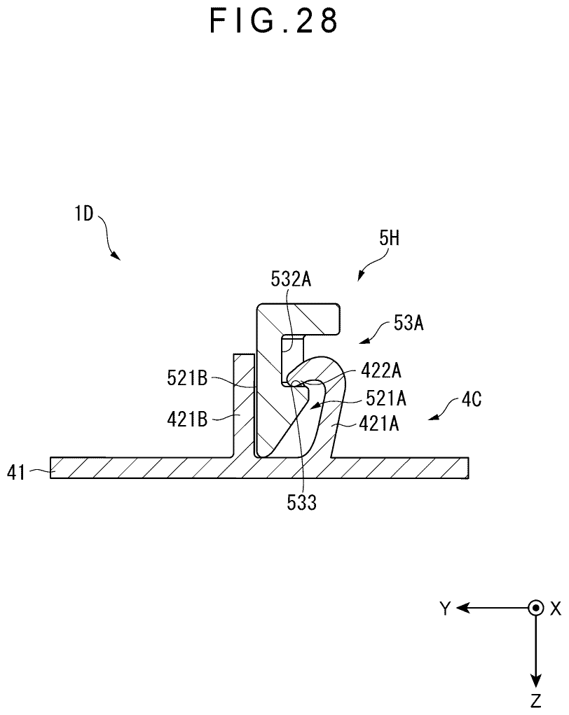

For instance, as illustrated in FIG. 28, a cover material attachment 1D may include a clip 4C and a clip engagement member 5H, each of which is asymmetric with respect to the XZ-plane. The clip 4C includes a base 41, a pair of legs 421A and 421B, and a claw 422A provided for either one of the legs (e.g., the leg 421A). The clip engagement member 5H includes an engagement portion 53A formed in either one of the lateral parts 521A and 521B (e.g., the lateral part 521A) and a disengagement guide (not illustrated) adjacent in the X-direction to the engagement portion 53A. It should be noted that the shapes of the leg 421B and the lateral part 521B are not particularly limited. For instance, it is preferable that the leg 421B supports the lateral part 521B on one side in the Y direction without interfering therewith in the Z direction.

In the above exemplary embodiments, the clip engagement members 5, 5A to 5G, and 5K include the disengagement guides 541A and 541B. The invention, however, is not limited thereto.

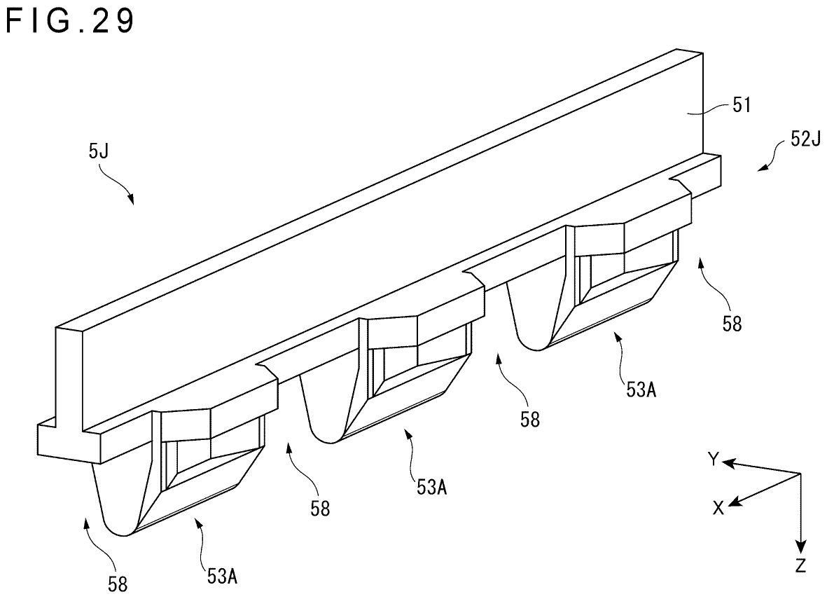

For instance, as illustrated in FIG. 29, a clip engagement member 5J may have slits 58 in place of the disengagement guides 541A and 541B. That is, in the clip engagement member 5J including a plurality of engagement portions 53A and 53B, the slits 58 cut in a body 52J may function as disengagement guides each of which guides the claws 422A and 422B of the clip 4 (see, for instance, FIG. 3) along the Z direction. The slit 58 is between ones of the engagement portions 53A (or the engagement portions 53B) adjacent in the X direction to each other. The slit 58 has a shape of a cut that is cut from a distal end of the body 52J in the Y direction. Further, the slit 58 may be formed outside in the X direction one end of the body 52J in the X direction, that is, formed outside in the X direction the engagement portions 53A and 53B located first or last out of the engagement portions 53A and 53B arranged in the X direction.

In such a configuration, the body 52 can be pulled from the clip 4 by an operation similar to those of the above exemplary embodiments.

The various components of the exemplary embodiments and modification examples described hereinabove may be combined as appropriate.

### EXPLANATION OF CODE(S)

1, 1A to 1D . . . cover material attachment, 2 . . . cushion material, 2A . . . groove, 3 . . . cover material, 4, 4A to 4C . . . clip, 40 . . . clip assembly, 41, 44 . . . base, 421A, 421B . . . leg, 422A, 422B, 423A, 423B . . . claw, 43 . . . restricting protrusion, 441 . . . tape, 442 . . . plate, 5, 5A to 5H, 5J, 5K . . . clip engagement member, 51, 57 . . . base, 52, 52D, 52G, 52J, 52K . . . body, 521A, 521B . . . lateral part, 53A, 53B . . . engagement portion, 532A, 532B, 538A, 538B . . . recess, 533 . . . engagement surface, 534 . . . bottom, 535 . . . edge, 536 . . . guiding inclined surface, 537 . . . restricting surface, 541A, 541B . . . disengagement guide, 551A, 551B . . . projection, 552A, 552B . . . engagement guide, 56 . . . restricting protrusion, 58 . . . slit, 61 . . . protrusion, 62 . . . stepped portion, 9 . . . seat, 91 . . . seat part, 92 . . . backrest part.

1. A clip engagement member configured to form a cover material attachment together with a clip that is to be attached to one of a cushion material and a cover material, the clip comprising a single claw or a pair of claws facing each other, the clip engagement member comprising:
a base that is to configured to be attached to another one of the cushion material and the cover material; and
a body extending from the base and that is configured to be inserted in the clip along an extending direction, the body comprising:
a pair of lateral parts facing opposite sides to each other in a thickness direction intersecting with the extending direction, at least one of the pair of lateral parts being configured to face the claw;
an engagement portion formed in the at least one of the pair of lateral parts, the engagement portion being engageable with the claw; and
a disengagement guide formed in the at least one of the lateral parts across a range from a) a position adjacent to the engagement portion in a length direction intersecting with each of the extending direction and the thickness direction to b) a distal end in the extending direction, the disengagement guide being configured to guide the claw in the extending direction.

2. The clip engagement member according to claim 1, wherein the disengagement guide has a flat shape extending across the range of the at least one of the lateral parts or comprises a stepped portion comprising a plurality of steps formed in the extending direction.

3. The clip engagement member according to claim 2, wherein a dimension of the body in the thickness direction defined by the disengagement guide is constant or gradually decreases toward the extending direction.

4. The clip engagement member according to claim 1, wherein:
the at least one of the pair of lateral parts is provided with a recess, and
the engagement portion comprises an engagement surface formed in the recess to face an opposite direction to the extending direction.

5. The clip engagement member according to claim 4, wherein the recess comprises a guiding inclined surface facing an opening of the recess, the guiding inclined surface extending from a bottom of the recess to an edge of the recess while being inclined to the length direction, the edge being adjacent to the disengagement guide.

6. The clip engagement member according to claim 4, wherein an edge of the recess protrudes toward the thickness direction beyond the disengagement guide adjacent to the edge.

7. The clip engagement member according to claim 1, wherein:
the body further comprises an engagement guide formed, in the at least one of the pair of lateral parts, on a side closer to the distal end in the extending direction than the engagement portion, and
a dimension of the body in the thickness direction defined by the disengagement guide gradually decreases toward the extending direction.

8. The clip engagement member according to claim 7, wherein the engagement guide comprises an inclined surface inclined to the extending direction or a stepped portion comprising a plurality of steps formed in the extending direction.

9. The clip engagement member according to claim 1, wherein the body further comprises a projection in the at least one of the pair of lateral parts, the projection projecting in the thickness direction.

10. The clip engagement member according to claim 1, wherein one or more engagement portions including the engagement portion and a plurality of disengagement guides including the disengagement guide are alternately formed in the length direction in the at least one of the pair of lateral parts.

11. The clip engagement member according to claim 10, wherein the body further comprises at least one restricting protrusion protruding in the thickness direction from one side in the length direction of the engagement portion.

12. The clip engagement member according to claim 1, wherein the engagement portion comprises a plurality of protrusions protruding in the thickness direction from the at least one of the lateral parts, the plurality of protrusions being arranged in the length direction.

13. A cover material attachment comprising:
the clip engagement member according to claim 1; and
the clip, the clip comprising:
a clip base that is to be attached to one of the cushion material and the cover material;
a pair of legs provided for the clip base, the pair of legs facing each other; and
the claw provided for at least one of the pair of legs.

14. The cover material attachment according to claim 13, further comprising:
a clip assembly comprising a plurality of integrally formed clips including the clip, the plurality of integrally formed clips being arranged in the length direction; and
a clip restricting protrusion, wherein:
the at least one of the pair of lateral parts comprises: one or more engagement portions including the engagement portion and a plurality of disengagement guides including the disengagement guide alternately formed in the length direction with a restricting surface formed between the engagement portion and the disengagement guide, the restricting surface facing the length direction, and
the clip restricting protrusion protrudes from the clip base between adjacent two of the clips, the clip restricting protrusion being configured to come into contact with the restricting surface.

15. The cover material attachment according to claim 13, wherein in a case where a recess is formed in at least one of the pair of lateral parts, the claw comprises a claw guiding inclined surface inclined to the length direction to face a bottom of the recess and face an edge of the recess, the edge being adjacent to the disengagement guide.

16. A cover material attachment comprising:
a clip; and
a clip engagement member,
wherein:
the clip comprises:
a clip base that is to be attached to one of a cushion material and a cover material;
a pair of legs provided for the clip base; and
a claw provided for at least one of the pair of legs; and
the clip engagement member comprises:
an engagement member base that is to be attached to another one of the cushion material and the cover material; and
a body extending from the engagement member base, the body being to be inserted into between the pair of legs along an extending direction; and
wherein:
the body comprises a plurality of engagement portions arranged in parallel at an interval along a length direction intersecting with the extending direction, the plurality of engagement portions being engageable with the claw,
the claw is configured to perform, in sequence, a first movement comprising a relative movement in the length direction from a state of being engaged with one of the engagement portions and a second movement comprising a relative movement in an opposite direction to the extending direction from a state of being placed between two of the engagement portions adjacent in the length direction, and
the second movement of the claw causes the body to come out from between the pair of legs.

17. The cover material attachment according to claim 16, wherein the body comprises a slit between ones of the engagement portions adjacent in the extending direction, the slit being cut from a distal end in the extending direction.
